(19) United States
(12) Patent Application Publication
(10) Pub. No.: US 2008/0299999 A1
(43) Pub. Date: Dec. 4, 2008

(54) SYSTEM AND METHOD FOR GENERATING MULTIMEDIA MESSAGES IN A MOBILE DEVICE

(76) Inventors: Kendall Gregory Lockhart, Laguna Beach, CA (US); Clayton Matthew Lockhart, Red Bank, NJ (US)

Correspondence Address: LOEB & LOEB, LLP, 321 NORTH CLARK, SUITE 2300, CHICAGO, IL, 60610-4746, US

(21) Appl. No.: 12/130,772

(22) Filed: May 30, 2008

Related U.S. Application Data
(60) Provisional application No. 60/941,531, filed on Jun. 1, 2007.
(60) Provisional application No. 60/941,538, filed on Jun. 1, 2007.
(60) Provisional application No. 60/941,543, filed on Jun. 1, 2007.
(60) Provisional application No. 60/941,552, filed on Jun. 1, 2007.
(60) Provisional application No. 60/941,557, filed on Jun. 1, 2007.
(60) Provisional application No. 60/950,666, filed on Jul. 19, 2007.

(51) Int. Cl. H04Q 7/20

(52) U.S. Cl. 455/466; 455/414.1; 715/716

(57) ABSTRACT

A system and method for generating multimedia messaging on a mobile device. The system includes a multimedia tool, and a user interface associated with the multimedia tool. The user interface is configured to permit a user to select a plurality of media objects and identify an order in which the plurality of objects are to be arranged. The multimedia tool is then configured to assemble the plurality of media objects into a multimedia message, select a format in which the multimedia message is to be transmitted, and transmit the message to at least one intended destination in the selected format.

### CROSS-REFERENCE TO RELATED APPLICATIONS

This application claims priority to U.S. Provisional Patent Application No. 60/941,531 entitled “Calendar/Planner and Message System and Method for Mobile Devices,” filed Jun. 1, 2007; U.S. Provisional Patent Application No. 60/941,538 entitled “Calendar/Planner and Message System and Method for Mobile Devices,” filed Jun. 1, 2007; U.S. Provisional Patent Application No. 60/941,543 entitled “Calendar/Planner and Message System and Method for Mobile Devices,” filed Jun. 1, 2007; U.S. Provisional Patent Application No. 60/941,552 entitled “Calendar/Planner and Message System and Method for Mobile Devices,” filed Jun. 1, 2007; U.S. Provisional Patent Application No. 60/941,557 entitled “Calendar/Planner and Message System and Method for Mobile Devices,” filed Jun. 1, 2007; and U.S. Provisional Patent Application No. 60/950,666 entitled “Calendar/Planner and Message System and Method for Mobile Devices,” filed Jul. 19, 2007.

### BACKGROUND

1. Field of the Invention

The present invention relates to services and software on mobile telecommunications devices, and more specifically to a software platform that integrates various functions including search, calendar/planner, messaging, and an active resources/assets directory unified together under a user generated lifestyle interlace in order to create a tool, useable especially on a mobile phone, that will help people to achieve, anytime, anywhere, the lives they want.

2. Description of the Related Art

The lives of consumers and business users are too fast-paced, complicated, and with overlapping roles; life quality is suffering. Mobile devices, applications, and networks, while somewhat useful to consumers and business users, do not offer an easy-to-use, time-saving integrated platform to navigate and manage the chaos in their lives.

One problem with current mobile phones is that they are too complicated for most people to use them. The designers put in so many different options, choices, and menus that the most basic needs people have of their phone become mired in technical complication. In addition, no mobile phone or software program on a mobile phone offers a simple, unified experience for the core things people need to do in order to achieve better lives: communicating, getting information, prioritizing time, and managing their lives.

Presently, on mobile phones, there exists access to many kinds of browsers, search engines, messaging and email engines, planners and calendars, and resource/asset directories. Many of these functions can be used via a mobile phone but they generally are not combined, organized, prioritized, tracked, monitored or related to each other in such a way that integrates their functions as one piece of software. Users do not have a simple, easy way to access and use these functions from one simple platform.

Additionally, while these various functions can be accessed via a mobile phone, there does not exist a single organizing piece of software, i.e. a user interface, that is related to each user's personalized life and heeds. Instead user interfaces on phones are generally very phone-centric in that they offer the user many options to do technical functions that phones are capable of doing, but generally users do not need to do in their daily lives.

Users find these interfaces complicated and rarely use anything other than a small percentage of the options offered. Current software is not organized around, does not mirror, and does not support the most important aspects of users daily lives. Most specifically, software is not organized around the roles, goals, and aspirations of each user. Instead mobile user interfaces other organizational choices based oil categories such as weather, clock, calculator, settings, stocks, maps, photos etc. Additionally, current software-on mobile phones does not recognize, in depth, who the user is, how the user behaves, what the user needs or wants to do in life, where in the functions and engines the user is, and what the next best and highest use of those functions should be for that user.

Further, current software on mobile phones does not offer several key approaches, functions, and features that would create the best system of support for users to achieve the lives they want. Search is limited to single searches on a search engine page. Search engines cannot refine results by using multiple searches from the same page. Search engines do not automatically refine searches by searching according to key life activity categories such as information, activity, people, places, and products. Additionally, search engines do not automatically detect a data base using an known organizational system other than key word, for example the Dewey decimal system.

Additionally, in current software, email messages cannot be configured to be sent/arrive based oil user-selected criteria, and thus do not currently offer users the option of having them arrive when they would be most meaningful to the recipient and most convenient to create for the sender. Nor can such configured timed messages be edited, recalled, replaced and/or deleted. Email messages also do not currently offer the option of creating multi-media messages that can be edited and previewed as the recipient would see them, before being sent.

Still further, current calendar/planners on mobile phones do not offer the ability to hot link any digital asset to an appointment, but rather just URLs. Additionally, current mobile calendar/planners do not allow users to view their planners by the categories and priorities that are individually important, but rather just by generic time segments. And lastly, current resource/asset directories on mobile phones do not track, monitor, and learn/adjust to users behavior patterns in order to deliver the optimum, relevant experience.

### SUMMARY OF DISCLOSURE

The present disclosure teaches various inventions that address, in part or in whole, this and other various needs in the art. Those of ordinary skill in the art to which the inventions pertain, having the present disclosure before them will also come to realize that the inventions disclosed herein may address needs not explicitly identified in the present application. Those skilled in the art may also recognize that the principles disclosed may be applied to a wide variety of techniques involving communications, organization, user-interfaces, and the like.

Accordingly, an object of the present invention it to provide systems and methods that implement a software platform as a mobile tool that people use to organize, support, and realize important parts of their lives, anytime and anywhere.

Another object of the present invention is to provide systems and methods that may be implemented as a software platform that is a mobility-enabled, open architecture middleware capable of implementation on pre-existing smart phones and in server complexes connected to the Internet, as well as to newly constructed devices.

Yet another object of the present invention is to provide systems and methods that implement a software platform in which search, planner, messenger, and resources/assets directory functions may co-exist under a user centered interface.

A further object of the present invention is to provide systems and methods that implement a software platform which uses a search engine that sits on top of and uses existing search engines and produces more refined and relevant results by allowing multiple inputs and triangulated outputs.

Still a further object of the present invention is to provide systems and methods that implement a software platform which employs a messaging system that creates more meaningful social support by giving each user the ability to create, edit and preview multi-media messages, and then enables the user to pre-set the time/date any message is sent.

Another object of the present invention is to provide systems and methods that implement a software platform that employs a calendar/planner which delivers a more organized life by letting users attach to an appointment a “live link” to any digital asset, and by allowing users view their lives as organized by personal life roles.

A further object of the present invention is to provide systems and methods that implement a software platform that employs an active resources/asset directory which monitors, tracks, learns from, and adapts to each user's actions and needs in order to provide a time-saving, customized and personalized experience.

These and other objects of the present invention are achieved in a messaging system for a mobile device. The messaging system includes a multimedia tool; and a user interface associated with the multimedia tool, the user interface being configured to permit a user to select a plurality of media objects and identify an order in which the plurality of objects are to be arranged; wherein the multimedia tool is configured to assemble the plurality of media objects into a multimedia message, select a format in which the multimedia message is to be transmitted, and transmit the message to at least one intended destination in the selected format. The plurality of media objects may include visually-perceivable objects, music objects, audio objects, and text objects.

In one aspect, the user interface may be configured to display a length associated with each of the selected plurality of media objects. The user interface may also include a plurality of timelines, including a first timeline having means for permitting user selection of one or more visually-perceivably objects, and means for permitting user selection of locations in the first timeline for each of the one or more visually-perceivable objects; a second timeline having means for permitting user selection of one or more music objects, and means for permitting user selection of locations in the first timeline for each of the one or more music objects; a third timeline having means for permitting user selection of one or more audio objects, and means for permitting user selection of locations in the first timeline for each of the one or more audio objects; and a fourth timeline having means for permitting user selection of one or more text objects, and means for permitting user selection of locations in the first timeline for each of the one or more text objects.

In another aspect, the multimedia tool may be further configured to access one or more properties stored in an active resources directory; and select the format in which the multimedia message is to be transmitted based on the one or more properties. The multimedia tool may also be configured to select a first device from a plurality of devices to perform assembly of the plurality of media objects into the multimedia message.

In another aspect, the present invention may also be achieved by a method for transmitting multimedia messages in a mobile device comprising the steps of receiving, via a multimedia tool, a plurality of user-identified media objects to be utilized for forming a multimedia message; accessing one or more properties in an active resources directory; selecting, based on the one or more properties, a format from a plurality of available formats in which the multimedia message is to be transmitted; and transmitting the multimedia message to one or more intended recipients in the determined format.

These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### BRIEF DESCRIPTION OF THE FIGURES

FIG. 1 illustrates one embodiment of a system in accordance with the present invention.

FIG. 2 illustrates a physical user interface used with one embodiment of the present invention.

FIG. 3 illustrates the relationship between the messenger, planner, and search suites in accordance with one embodiment of the present invention.

FIG. 4 illustrates a role-based organization structure used in accordance with one embodiment of the present invention.

FIGS. 5a-5d illustrate one example of a graphical user interface embodying the organizational structure set forth in the illustration of FIG. 4 and demonstrating one embodiment of the present invention.

FIG. 6 illustrates one embodiment of an active resources directory in accordance with the present invention.

FIG. 7 is a flow diagram illustrating a process for creating roles (and the underlying data structure for that role) in accordance with one embodiment of the present invention.

FIG. 8 is a flow diagram illustrating a process for integrating the active resources directory with the various functions, applications, and objects in accordance with one embodiment of the present invention.

FIG. 9 illustrates importing preexisting data into the active resource directory in one embodiment of the present invention.

FIG. 10 illustrates navigation paths between the messenger, planner, and search suites and the associated session-based file in accordance with one embodiment of the present invention where the end user is presently using the email function.

FIG. 11 illustrates performing session-based navigation using the session-based file of FIG. 10 in accordance with one embodiment of the present invention.

FIG. 12 illustrates navigation paths between the messenger, planner, and search suites and the associated session-based file in accordance with one embodiment of the present invention where the end user is presently using the multimedia file function, having just come from the email function as depicted in FIG. 10.

FIG. 13 is a flow diagram illustrating functions that may be performed by the messenger suite in accordance with one embodiment of the present invention.

FIG. 14 illustrates filtering incoming messages in accordance with one exemplary embodiment of the present invention.

FIG. 15 illustrates one embodiment of the multimedia tool in accordance with the present invention.

FIG. 16 illustrates one embodiment of a method for transmitting a multimedia message in accordance with the present invention.

FIG. 17 is a flow diagram illustrating the functions of the message transmission manager in accordance with one embodiment of the present invention.

FIG. 18 is a flow diagram illustrating an embodiment for replacing queued message in accordance with one embodiment of the present invention.

FIG. 19 is a flow diagram illustrating one embodiment for replacing received message in accordance with one embodiment of the present invention.

FIG. 20 is a flow diagram illustrating an embodiment of certain functions of the planner suite in accordance with one embodiment of the present invention.

FIG. 21 illustrates one embodiment of certain functions of the calendar applications in accordance with one embodiment of the present invention.

FIG. 22 illustrates one embodiment using voice commands illustrated with the calendar function in accordance with one embodiment of the present invention.

FIG. 23 is a flow diagram illustrating one embodiment of the functions of the search suite in accordance with one embodiment of the present invention.

FIG. 24 illustrates one embodiment for performing a hierarchal search in accordance with one embodiment of the present invention.

FIG. 25 illustrates one embodiment of a user interface for initiating a search in accordance with one embodiment of the present invention.

FIG. 26 illustrates one embodiment for performing a multiple database search in accordance with one embodiment of the present invention.

FIG. 27 is a flow diagram illustrating one embodiment of a search utilizing a library adapter in accordance with one embodiment of the present invention.

### DETAILED DESCRIPTION

The present invention provides a system and method that can be utilized with a variety of different client devices, including but not limited to PDA's, cellular phones, laptops, and other mobile devices, and enables people to organize, support, and realize various aspects of their lives. Thus, while the invention may be embodied in many different forms, the drawings and discussion are presented with the understanding that the present disclosure is an exemplification of the principles of the inventions disclosed herein and is not intended to limit any one of the disclosed inventions to the embodiments illustrated.

In one aspect, the present invention provides relevant resources, meaningful support, and time-saving tools desired by users in today's busy world are delivered and integrated into one mobile system. To this end, an illustrative system of the present invention integrates messenger, planner, search, and resources/assets directory functions under a single graphical user interface. Each of these elements provides various functionality that is designed to enhance various roles in users' lives. To mirror the most important and natural roles in a user's life, the present invention may employ a life/role-centered interface in order to access and guide all the functions of the present illustrative system. All the system functions can be accessed via various role-related “windows” or lists, and the properties for each role-related window, as well as the objects accessible within each role-related window, are carried and/or tracked across the system. Additionally, the present invention may employ an active resources directory that monitors, tracks, learns from, and adapts (especially with continued use of the system) to each user's actions and needs in order to provide the most time-saving, customized, and personalized experience.

Various messaging, planning and search functions also provide additional, independent advantages. For example, one aspect the present invention may include a messaging system that creates more meaningful social support by giving each user the ability to create, edit and preview multimedia messages, and by giving each user the ability to pre-set criteria upon which any message is sent. Another aspect of the present invention may include a planner that delivers a more organized life by letting users attach to an appointment a live link to any digital asset, and by letting users view their lives as organized by their personal life-related roles. The present invention may also employ a search functions that sits on top of and uses existing search engines to produce more refined, relevant results by allowing one or more of the following: multiple search inputs for hierarchal searching, simultaneous searching of multiple databases, and user-scheduled-searches of both public and private databases.

In one embodiment, the systems and methods provided in accordance with the present invention are mobility-enabled, and are comprised of a software suite configured for implementation on mobile devices (e.g. cellular telephone, radiotelephone, smart phone, wirelessly-enabled laptop and Personal Digital Assistant (“PDA”)), servers connected to the Internet, and the like. In one embodiment, the system can reside on top of a commodity mobile device operating system and any pre-loaded utility applications. In another embodiment, the platform of the present invention may also be accessible from a personal computer.

1. System Architecture

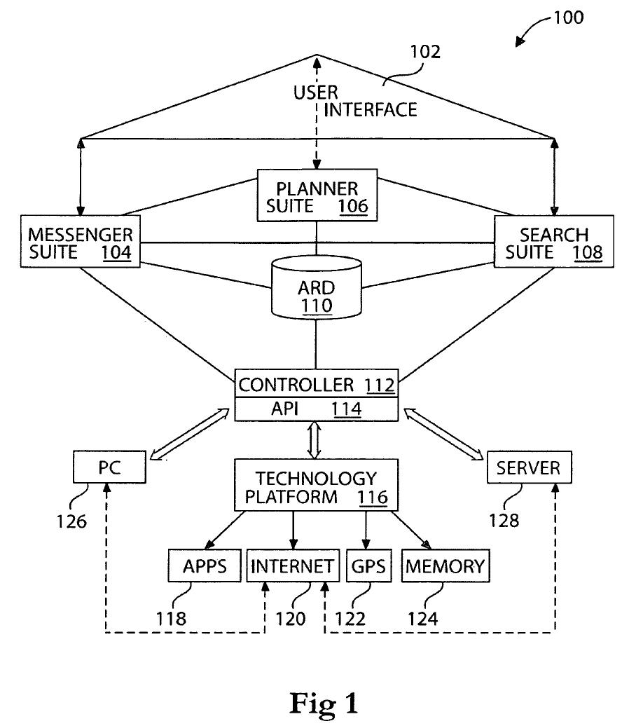

FIG. 1 illustrates one exemplary embodiment of an illustrative system 100 that may be utilized in conjunction with a client device, such as a mobile phone, in accordance with the present invention. As shown, the system includes a user interface 102 that permits access to various functions and applications from each of a messenger suite 104, a planner suite 106, and a search suite 108. Each of these suites 104, 106, and 108 is in turn coupled to each other as well as an active resources directory (ARD) 110 that is configured to track and store information regarding a user's actions on the system and/or various objects and information utilized by the system. A controller 112 is also coupled to, and includes program instructions for integrating the functionality of, the active resources directory 110, the user interface 102, the messenger suite 104, the planner suite 106, and the search suite 108. The controller 112 is also configured to communicate, via an Application Programming Interface (API) 114, with a technology platform 116 that resides on the client device. Via the technology platform 116, the controller 112 may further communicate and interact with various applications 118, internet browsers 120, Global Positioning Systems (GPS) 122, and device memory 124 resident to the technology platform 116. The applications 118 may include any type of application including native email applications, planner applications, internet browsers, music players, image viewers, video players, games and the like. As shown in FIG. 1, the controller 112 may also be capable of communicating with a one or more remote personal computers 126 and/or remote servers 128, each of which may include software to interoperate the controller 112. Alternatively, the controller 112 may communicate with the one or more remote personal computers 126 and/or the remote servers 128 via the Internet 120.

In accordance with the present invention, the system 100 is preferably platform and device independent. Accordingly, present invention is not limited to any specific type of technology platform nor any specific type of client device. For example, the technology platform may be Microsoft Windows Mobile, Palm OS, Blackberry, Apple OS, Android, or any other technology platform. For purposes of this disclosure, the present invention has been generally described in accordance with features and interfaces that are optimized for a cellular phone utilizing a Microsoft Windows Mobile 6.0 platform, although one skilled in the art would understand that all such features and interfaces may also be used and adapted for any other platform and/or device.

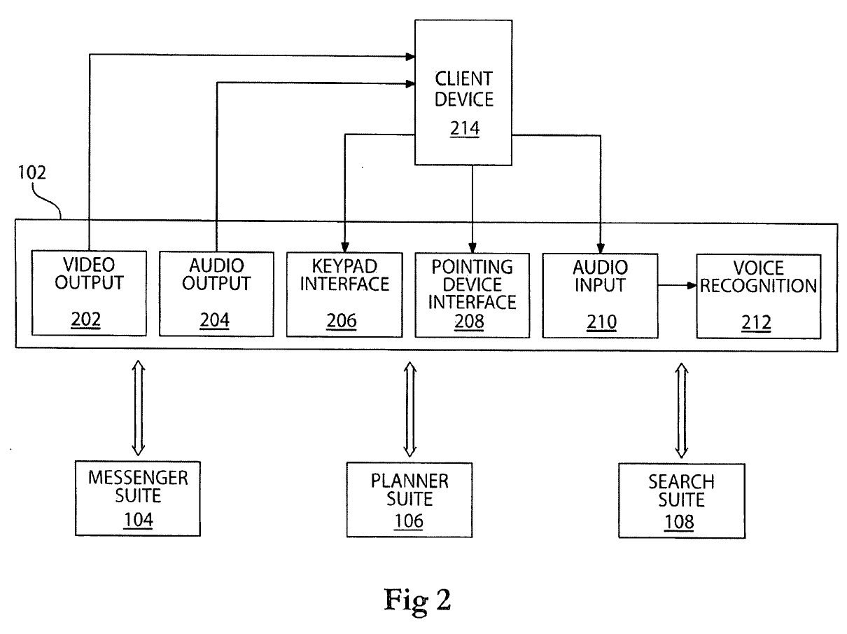

FIG. 2 illustrates one exemplary embodiment of an integrated user interface 102 that may be employed to guide a user and enable user access to the various functions provided in the system, such as those in the messenger suite 104, planner suite 106, and search suite 108, or in any resident applications associated with the technology platform 116. In the embodiment illustrated, the user interface 102 includes a video output 202 and an audio output 204 to output video and audio to a display and speaker, respectively, of a client device 214. The user interface 102 may also include a keypad interface 206 for receiving user input through an associated keypad, and/or a pointing device interface 208 for receiving user input via an associated pointing device (such as a touchscreen, jog dial, trackball, mouse, etc.). The user interface 102 may also include an audio input 210 for receiving audio via a microphone in the audio device. The audio input 210 may in turn be coupled to a voice recognition software 212, thus enabling various functions of the system to be accessed via user-spoken commands.

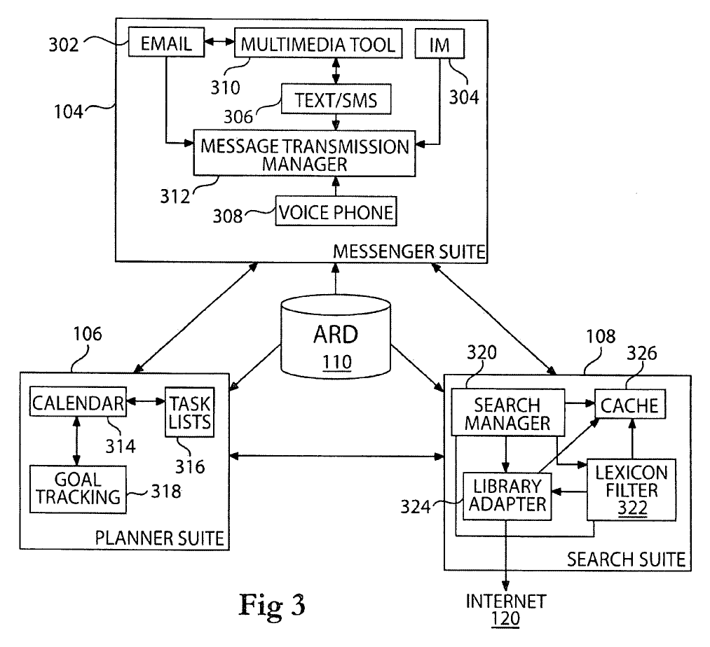

FIG. 3 illustrates one exemplary embodiment of the messenger suite 104, planner suite 106, and search suite 108 that may be utilized in the present invention. In the embodiment shown, the messenger suite 104 includes an email application 302, an instant messenger (IM) application 304, a text/SMS messaging application 306, and a voice phone application 308. The messenger suite may also include a multimedia tool 310 for compiling multimedia messages that can be transmitted using the email, IM, or text/SMS functions, and a message transmission manager 312 configured to control transmission of messages based on one or more user-specified criteria.

The planner suite 106 may include various applications for planning, organizing, and scheduling a user's life. Such applications may include a calendar application 314, a task lists application 316, and a goal tracking application 318.

The applications in the messenger and planning suites preferably sit on top of and are configured to interoperate with applications 118 resident on the technology platform 116. For example, the email application 302 in the messenger suite 104 may interface with a preexisting email application on the technology platform such as Microsoft Outlook, Lotus Notes, or any other resident email application. Alternatively, the email application 302 may also be configured to interoperate with one or more web-based email applications such as Yahoo Mail, GMail, Microsoft Hotmail, and the like. Similarly, IM, Text/SMS, Voice Phone, Calendar, Task List, and Goal Tracking applications may also each be configured to sit on top of and interoperate with resident or web-based applications that perform these functions. As such, users that employ or install the present system on a client device can maintain and utilize pre-established accounts via user interface 102. System 100 may also use proprietary email, IM, Text/SMS, Voice Phone, Calendar, Task List, and Goal Tracking applications.

As further shown in FIG. 3, the search suite 108 may be configured to interface with existing Internet browsers and/or Internet search engines in order to conduct more refined and relevant searches. In particular, the search suite 108 includes a search manager 320 for conducting hierarchal searches using multiple user-identified search terms and simultaneous searches of multiple databases, a library adapter 324 for providing relevant search results from pre-organized databases, a lexicon filter 322 to filter toward improving the search quality of searches performed by the search manager 320, and a cache 326 for storing intermediate and final search results. The functions and processes performed by the various components in the messenger, planner, and search suites will be discussed in more detail below.

It should also be understood that the applications shown for each of the messenger, planner, and search suites are but examples of applications that may be employed and are not intended as being either exhaustive or required. For example, in certain instances, various features may not be provided due to technical limitations of the client device or associated technology platform. Certain applications and functions may also be added or removed based on the design choice of the manufacturer, provider, or carrier.

2. Role-Based Organizational Structure

In accordance with one aspect of the present invention, the system may be configured to obtain, organize, and display information via the user interface 102 using a user centered and/or generated role-based organizational structure. That is, for each user, a plurality of windows (which may be accessed via folders, portals, doorways and/or files, etc.) relating to the various role-related activities for that user may be dynamically established by the user. Information in the system may then be obtained, organized, and displayed to the user based on the role to which that information is relevant, as opposed to typical systems that provide organization by application or location of a saved file. For purposes of this disclosure, the established roles may include any role that plays a part in a user's life. Examples of such roles may include Health, Family, Consumer, Business, or Military. Roles may also include various hobbies, interests, goals, or activities such as Sports, Gardening, Collecting, etc. Sub-windows may also be created within each role to identify different aspects of the roles. For instance, the “Business” role could have sub-roles for each part-time job held by the user. Of course, any other roles may also be established depending on the needs of a user. The role-based windows and their properties may be preconfigured or populated directly by the user.

Thus, in one embodiment, the user interface 102 may be configured to manage, prioritize and integrate information relating to each role and permit the steps of, (i) selecting a role, (ii) responsive to selecting the role, performing at least one of managing, prioritizing or integrating one or more roles to create various aspects of the user interface and (iii) displaying the results of the managing, prioritizing or integrating to the user. The user interface may also further be configured to (i) provide organization of actions, junctions and data on the system, (ii) enable a user to deploy multiple organizational roles simultaneously, (iii) enable a user to deploy multiple versions of role-related functions simultaneously with other system functions and (iv) enable a user to set multiple roles to automatically contact the user at pre-set times with search results, updated results, actions and choices.

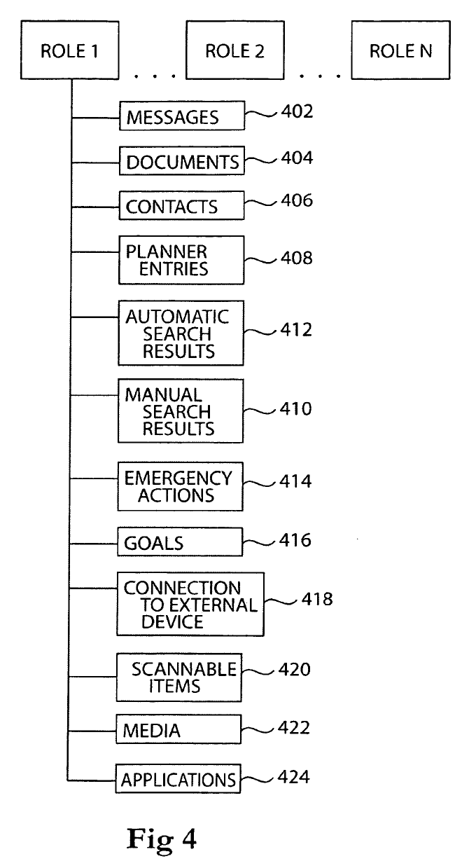

FIG. 4 shows one exemplary embodiment of a role-based organization structure and the types of information that may be associated with a role in the present invention. In this example, a plurality of role-based windows (Role 1 through Role N) are illustrated. Each role-based window may include information relevant to that role in the user's life. As illustrated for “Role 1,” such information may include messages 402 (e.g., email, IM, text/SMS, multimedia, or voice messages), documents 404, contacts 406, planner entries 408, manual search results 410 (i.e. results of one time searches initiated by the user), automated search results 412 (i.e. searches that are performed continuously or periodically), emergency actions 414, goals 416, connections to external devices 418, scannable items 420, media 422 (such as music, videos, photos, etc.), and applications 424. The ordering of these pieces of information may also be user defined. So, for example, a user may place goals 416 first because the order may affect the order in which the information is displayed, updated and the like.

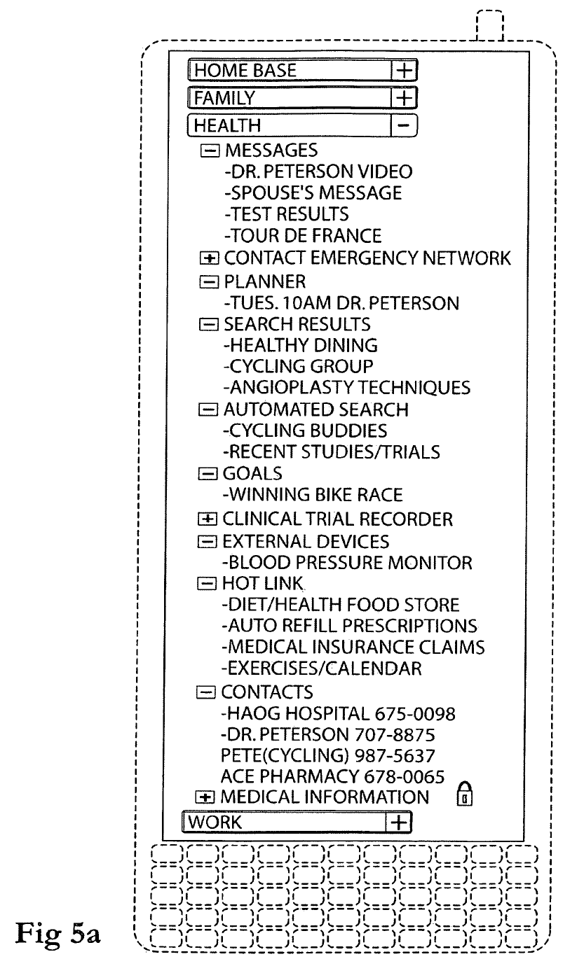

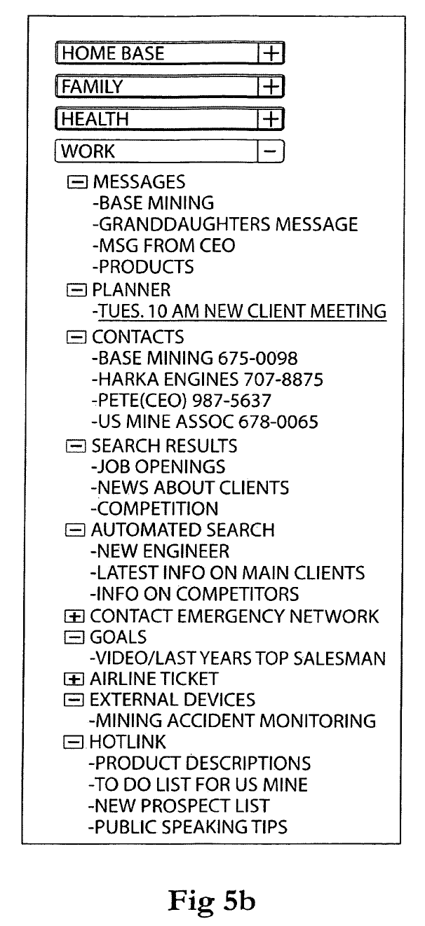

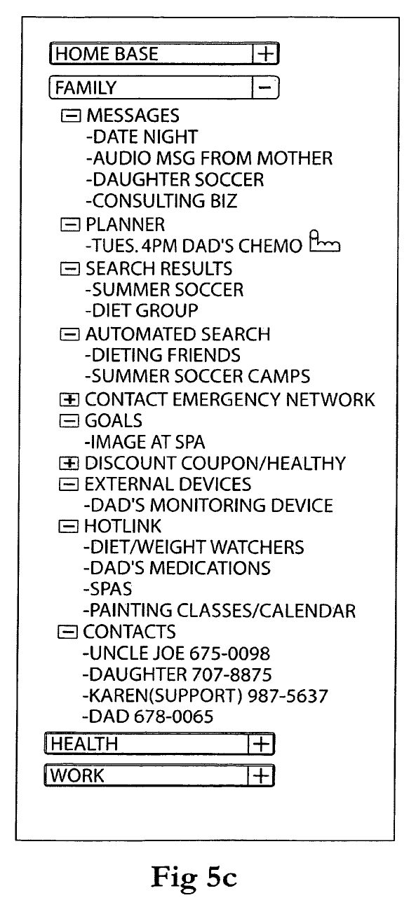

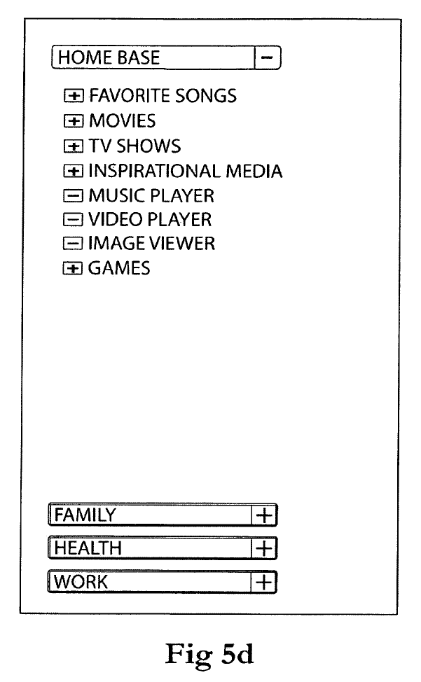

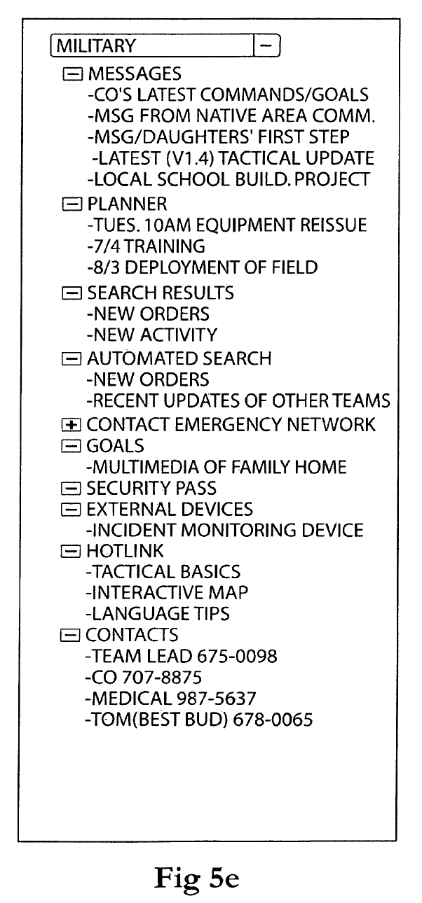

To better illustrate this aspect of the present invention, several real-life examples of role-based windows and the types of information that may be associated with that role are illustrated in FIGS. 5a-5d. Referring first to FIG. 5a, one example of a Health related role window (which, as shown, may be employed it conjunction with a mobile device) is shown for a user has had heart-related medical issues and has now taken up cycling to stay healthy. As shown in this example, messages received from a health professional (“Dr. Peterson”) may be automatically distributed to and organized within the Health window. As in this example, the message may include an instructional videos received from a doctor or messages containing test results. In this example, the Health window was configured to display messages relating to the user's fitness-related activities (i.e. cycling) such messages relating to the user's training for the Tour de France. In this example, a message from the user's spouse also appears in the Health category most likely because it references either the user's medical issues (e.g. “Is your heart test info back?”), a doctor's name (“Have you heard from Dr. Peterson?”) and/or cycling (e.g. “I picked your bicycle up at the shop.”), however depending upon user programming, the message may be included in the Health role for a variety of reasons, such as referencing health issues of others, such as the spouse, offspring or a relative or including a word the user designated as health related (e.g. cholesterol, diet, infection).

As illustrated in the example of FIG. 5a, the Health window may also include relevant planner entries (e.g. appointments with doctors, physical therapists, personal trainers, masseuses, etc.), results from single manual searches (e.g. search results relating to healthy dining, cycling groups, and angioplasty techniques), results from pre-established automated searches (e.g. for cycling buddies in the user's area and most recent medical studies/trials), a link to an emergency medical network, health-related goals (i.e. winning a bike race), links to a clinical trial recorder, available connections to external devices (e.g. a blood pressure monitor, a glucose monitor), hot links to relevant information (e.g., Internet links for health food stores, automatic prescription refills, and insurance claim filing, and links to calendar entries relating to exercising), and contacts (e.g. hospital, doctor, pharmacy, and cycling buddies). As illustrated, the Health role may also contain aspects of the user's Medical Information for use in emergencies (e.g. prescriptions taken, blood type, allergy information, and historical information from the external devices). As further illustrated by the “lock symbol,” any files that are accessible via the system 100 may be individually locked. In one embodiment, this lock could be opened by the cellular telephone provider at the request of a paramedic, hospital, police, or similar emergency personnel.

Turning to FIG. 5b, one example of a Work related role window is illustrated as now being expanded for the same user as FIG. 5a (while the user's Health related window has been collapsed). As can be seen, the user in this illustrative example is a salesman in a mining company. In this example, work related message (such as those regarding base mining, message from the CEO, or latest information regarding products) are automatically organized within the Work window. As shown, messages from family members (e.g. the granddaughter) may also appear with or otherwise be organized within the Work window depending upon the user-selected configuration of the system.

The Work window may also include relevant planner entries (e.g. client meetings), results from single manual searches (e.g. job openings, and news about certain clients and competing companies), results from pre-established automated searches (e.g. searches for a new engineer, latest information on main clients, and latest information on main competitors), a link to an emergency network (e.g. to report mining accidents in this example), work-related goals (e.g. video of user receiving award for top salesman), links to scannable airline tickets, available connections to external devices (e.g. mining accident monitors), hot links to relevant information (e.g. links to product description brochures, to do lists, lists of potential prospects, and public speaking tips), and contacts (e.g. base mining company, supplier, CEO, and business association).

Conflicts may occur in planning events between various life-roles. By way of highlighting the conflicting entry a user can be informed that two scheduled activities conflict. For instance, as illustrated in FIG. 5b, the new client meeting scheduled for Tuesday at 10 am conflicts with the appointment with Dr. Peterson (sec FIG. 5a). In this example, the system has decided (perhaps based on prior experience, perhaps from user programming or perhaps from some other data, such as the earlier date of entry into the database) that the appointment with Dr. Peterson is more important, so it highlights the “new client meeting” as a conflict. Of course, it should be understood that a system that highlights both conflicting entries is also contemplated. In any event, where a scheduling conflict is noted, the system may also provide the ability to display the two events on the display simultaneously to facilitate the selection as between event. Moreover, seemingly conflicting events may not be conflicting because they merely reflect reminders that another (e.g. the user's spouse) is meeting, for instance, Dr. Peterson, while the user meets with the new clients.

By comparing FIGS. 5a and 5b it can also be seen that the order in which the information may be selected by the user. For instance, in this example, the Contacts in the “Work” window appear higher in the list of information than in the “Health” role. User selectable ordering of the information may be of particular importance where the mobile device being used has a small display, such that even when each of the information types (e.g. Messages, Planner, Contacts, Search Results, Automated Search, Goals, etc.) is collapsed (by selecting the “−” before each type of information) there still may not be sufficient room on the device to show the entire list. In this context it should also be noted that in this illustration built on Windows Mobile, expandable lists are denoted by the “+” that appears in the illustration of FIG. 5b, for example, at “CONTACT EMERGENCY NETWORK.”

In FIG. 5c, one example of a Family related role window is illustrated for the user of FIGS. 5a and 5b (both of which have been collapsed for purposes of this figure). In this example, family related messages (such as those regarding a date night with the user's spouse, an audio message from mother, an SMS message from the user's daughter regarding soccer practice, and a message relating to a recent consulting project) are automatically organized within the Family window. Like the “Work” and “Health” windows, the Family window may also include relevant planner entries (e.g. a father's chemotherapy appointment depicted in FIG. 5c with a reminder to send Dad a message reminding him about the appointment), results from manual and automated searches (e.g. summer soccer camps, and dieting friends), a link to an emergency contact network (e.g. emergency contact for daughter's soccer carpool), relevant goals (e.g. photographic image of the user during a prior spa vacation), links to scannable coupons for healthy foods, available connections to external devices (e.g. Dad's medical monitoring device), hot links to relevant information (e.g. links to Weight Watchers®, lists of father's medications, lists of spas, and calendar entries of available painting classes), and contacts (e.g. Uncle Joe, daughter, Karen, and Dad). Notably, in the contacts of this illustrated example, the user decided to list the contacts in an order different from alphabetical. The system may support a function that ranks the contacts toward creation of a particular order. This ranking may be manually performed by the user, affected by the current status of the system (e.g. an upcoming appointment with or a recently received urgent email from a contact temporarily promoting that contact's ranking), and/or based on other criteria.

FIG. 5d illustrates one example of a home-base role window that may be utilized by the user of FIGS. 5a-c for identifying objects and assets that the user desires to have readily accessible. For example, as shown in FIG. 5d, the home base window may have favorite songs, movies, tv shows, as well as inspirational media. The home base window may also contain direct links to certain applications such as a music player, video player or image viewer, or various games.

Turning to FIG. 5e, one example of a role window that may be utilized for military-related activities is illustrated. In this embodiment, military-related messages (such as those regarding a COs commands and goals, tactical updates, and messages from native area commanders) are automatically organized within the Military window. Messages relating to various projects (such as construction of a local school building) and even a message from family may also be organized within the Military window depending upon the configuration selected by the user or pushed down from the network administrator, particularly in the instance of a military use.

The Military window may also include relevant planner entries (e.g. time/date for equipment reissue, date of upcoming training, date of upcoming deployment), results from manual and automatic searches (e.g. new orders and activities, and recent updates regarding other teams), a link to an emergency contact (e.g. emergency contact for command control), relevant goals (e.g. multimedia message of family), links to scannable security pass, available connections to external devices (e.g. incident monitoring device), hot links to relevant information (e.g. links to tactical basics, interactive map, and language tips), and contacts (e.g. team leader, CO, medical personnel, and best friend).

As further illustrated in FIG. 5d, the information displayed by Planner may also be defined by the user. In this example, the user indicated that certain “appointments” beyond the present week should be displayed. The display of these appointment may be due to their significance, because travel is required, or simply because the user programmed the system to display any appointments within three months of the present day. As further illustrated, as appointments become close enough in time, a date display may give way to a day and time display of the appointment.

Of course, while each role-related window is preferably associated with different information to permit a user to easily access different aspects of their lives, certain priority information, including emergency messages or messages from certain individuals may be distributed to multiple, if not all, role-related windows. As shown in FIGS. 5a-d, the order in which information is provided for each role-related window may also be altered based on the most important or desired information for that role and roles may be expanded or collapsed as suits the users immediate need for information.

3. Active Resources Directory

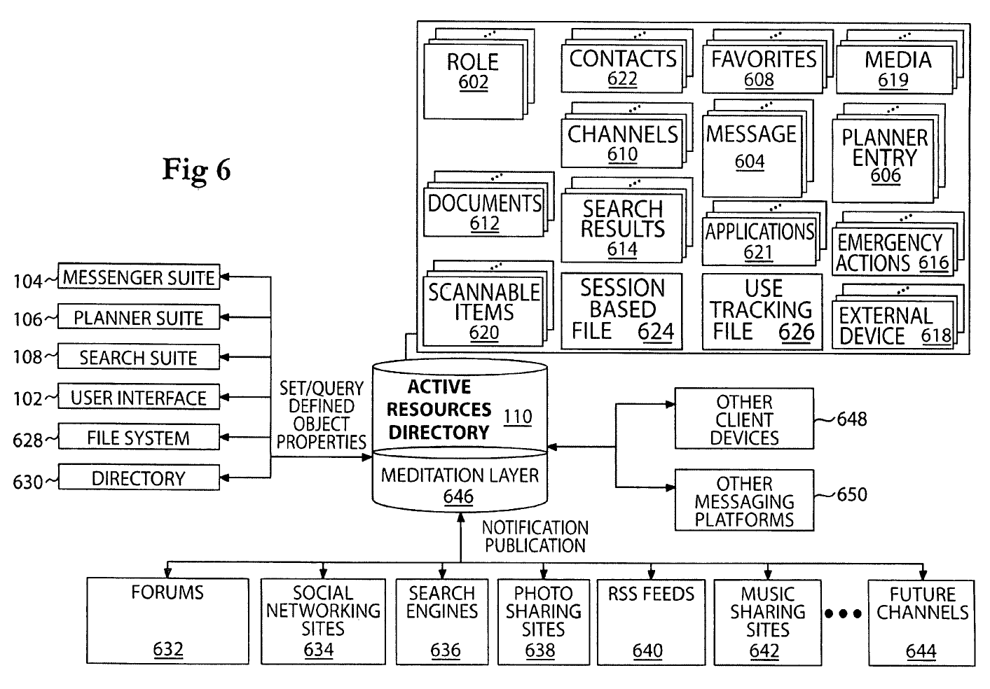

To enable the role-related organization structure described above, the active resources directory 110 is configured to store key properties of objects that may be utilized by each of the user interface 102, messenger suite 104, planner suite 106, and search suite 108, and to track real-time status and usage associated with the system 100 in order to provide integration of the various system functions. As illustrated in FIG. 6, the active resources directory 110 may store information identifying the properties for each of the role-based windows 602 established for or by the user, as well as the properties of various objects that may be organized within each role, including messages 604, planner entries 606, user favorite links 608, user-subscribed channels 610, documents 612, search results 614, potential emergency actions 616, available connections to external devices 618, media 619, scannable items 620, and applications 621. The active resources directory 110 may also store information regarding contacts 622, which may include not only the properties of each particular contact (i.e. name, company, relationship, priority, phone number, email address, IM screen name, etc.), but also real-time status or presence updates for each contact (e.g. GPS location, whether the contact is logged into a certain application, made a phone call recently, etc.).

In one embodiment, the active resources directory 110 may also store a session-based file 624 to track a user's short-term usage during a particular session, as well as user tracking file 626 regarding a user's long-term usage. Of course, it is understood that other types of information may also be tracked based on the full set of applications and features that are provided. Certain data from the active resources directory 110, preferably on an opt-in basis, may also be published or made available for access by third parties and/or other client devices that employ the system described herein below.

As shown, the active resources directory 110 interfaces with each of the messenger suite 104, planner suite 106, search suite 108, and user interface 102, as well as the file system 628 (which may include the names, pathnames, and sequences of files) and directory 630 (which may include previously stored information of various contacts). The active resources directory 110 may also be configured to communicate and interact, via the Internet, with one or more channels including web-based forums 632, social networking sites 634 (such as Facebook, YouTube and MySpace), search engines 636 (such as Google, Yahoo, and MSN), photo sharing sites 638 (such as Flickr and Twitter), RSS feeds 640, music sharing sites 442 (such as Last.fm), and any other future channels 644. Access to such channels may be conducted through a mediation layer 646 that permits the active resources directory 110 to log into and properly access information stored with each of the channels, receive notifications, and publish information to the channels. As shown in FIG. 6, the active resources directory 110 may also be configured to communicate with other client devices 648 and other messaging platforms (e.g. other IM or email platforms).

Although the active resources directory 110 is illustrated as a single database, it should also be understood that the active resources directory may be distributed among a plurality of individual databases. Select information in the database (such as information that is to be published or shared with other client devices) may also be stored on a remote server (e.g. server 128), either separately or in conjunction with active resources directory information from other client devices in order to simplify access to the data by multiple client devices. For purposes of this disclosure, portions of the active resource directory 110 stored on the client device are referred to as “ARD client components” while portions of the active resource directory stored on a remote server are referred to herein as “ARD network component.”

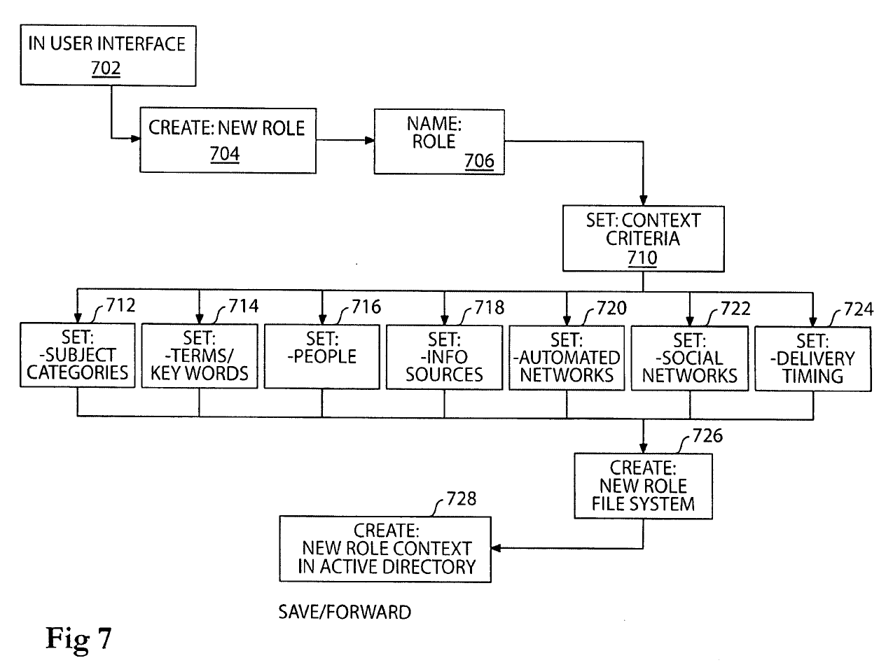

FIG. 7 is a flow diagram illustrating one embodiment for creating and setting the properties for a role-related window. The user begins creation of a new role-related window or subwindow by choosing a create role function via the user interface 102 (step 702), setting the name for the role, such as “Work,” “Health,” “Family,” “Hobby: Gardening” (step 704) and then creating and setting the parameters (also referred to as “context”) for the role-related window (step 710).

As shown in FIG. 7, setting the context may include setting various contextual properties including subject categories for the role (step 712), terms/keywords to identify the role (step 714), people and groups that are to be associated with the role (716), information sources that are to be accessed via the role (718), automated networks that are to be accessed via the role (720), and social networks that are to be accessed via the role (722). Setting the context may also include setting the delivery timing for the role (step 724), which permits a user to select whether information related to the created role is provided to the user continuously, only during certain times or days, or at preset times. From these properties, a file system is automatically created for the user associated with this role (step 726). The created role and its properties are then written to the active resources directory 110 (step 728).

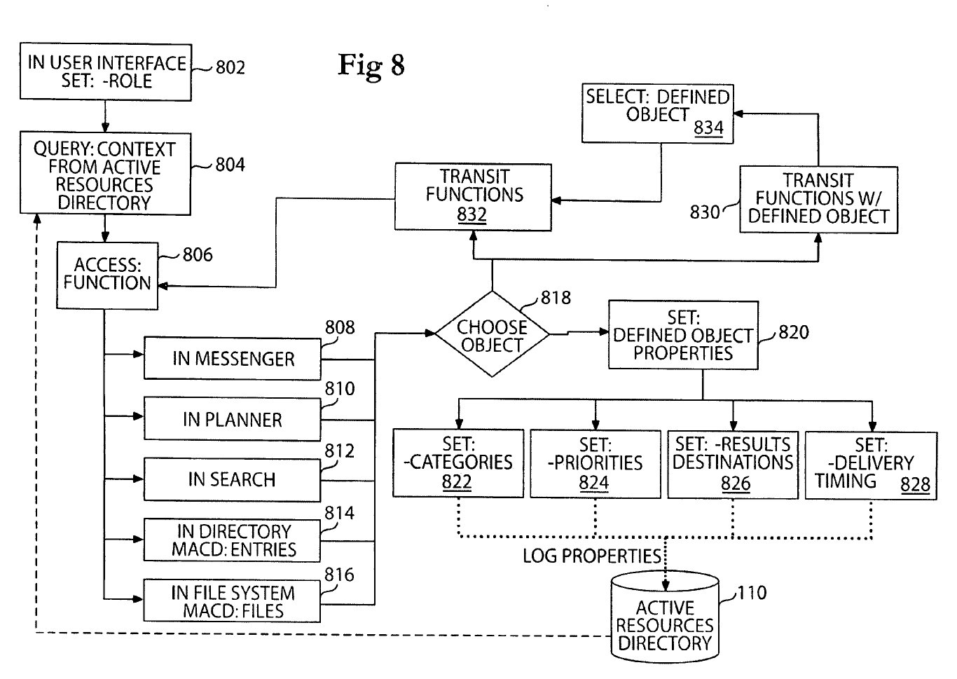

FIG. 8 is a flow diagram illustrating one embodiment of the integration of the active resources directory 110 with the various functions, applications, and objects in the system. Beginning in the user interface, the user selects a role window (step 802), which launches a query to the active resources directory (step 804). The active resources directory 110 stores pointers to various objects, object properties, including those for contact information, messages, planner entries, URLs, IM states, channel feeds, search engine results, and anything that is critical to be labeled and found automatically by the system for display to the user upon selection of a particular role window. The relevant information for each object and its respective properties can be stored on the client device, oil a personal computer, or on a network server. The query response contains a pointer to the context associated with the role, which may include the role-related subjects, categories, words/terms, people groups, info sources, networks, timing parameters, etc.

After choosing a role-related window, the user may chooses to access certain aspects of the system (step 806). This may include accessing functions or applications from the messenger suite 104 (step 808), planner suite 106 (step 810), or search suite 108 (step 812). The user may also choose to access directory entries (step 814) or browse the file system (step 816) associated with either the operating system of the client device or remotely on a network server. As the user exercises the individual functions, various objects can be chosen or created by the user (step 818). As noted above, such objects may include messages (text, IM, voicemail, email, multimedia), planner entries, contacts, documents, searches, URLs, etc. Once an object is chosen or created, the user may also set properties for that object (step 820). Setting the properties may include setting the category (step 822), priority (step 824), delivery destination (step 826) and timing (step 828). Once set, each of the properties may be logged in the active resources directory 110.

In one embodiment, setting the categories for an object may include identifying one or more, and preferably, three characteristics for the object (a concept similar to meta-tags). Setting the delivery destination includes identifying the location where the object is to be delivered, if applicable. This may include the relevant roles, as well as applicable file locations. Setting the timing may include identifying a certain time or day when the object is to be presented to the user. As such, the user can configure certain objects to be delivered only at those times when the user is either ready or interested in reviewing such object. The identity and location of the object, along with the set properties are then recorded in the active resources directory 110 in order to classify and organize all such objects.

Additionally, the user can choose to transit or switch from one function or application to the next, either with a chosen object (step 830) or without the chosen object (step 832). If the user select to switch to a new function or application with a chosen object, the user selects an object (step 834), in which case the contextual properties for the object are maintained and transferred to the new function or application. When the user accesses the subsequent function or application, the chosen object can thus be inserted into or associated with another object or its properties can be used to define navigation choices in the subsequent function or application. For example, a user may access an email message regarding a client appointment while accessing the messaging suite, and identify the message as being work-related. The user may then select that message, move to the calendar and insert a link to the message in a new calendar entry reflecting the appointment. The new calendar entry, by virtue of the contextual properties previously set for the email message, may be automatically identified and recorded in the active resource database 110 as also being related to the user's Work role.

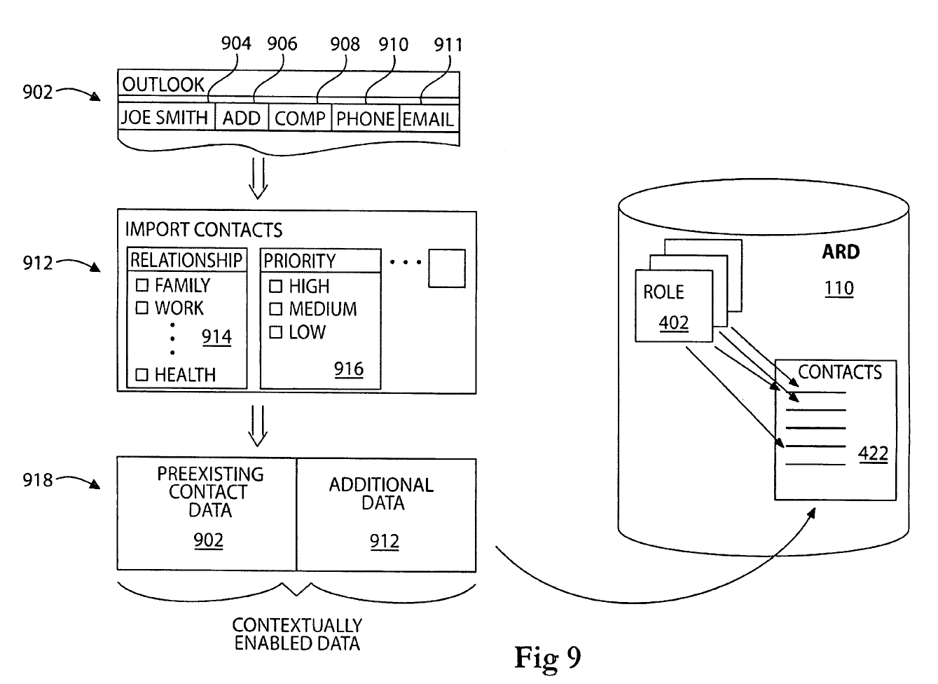

Various objects and properties may also be imported to the active resources directory 110 from other applications. FIG. 9 illustrates one example of importing contact information from Microsoft Outlook. However, it will be understood that information may be imported to the active resources directory 110 from any resident or web-based application. As shown in FIG. 9, one contact entry for an individual named Joe Smith has been selected for import from Microsoft Outlook into the system of the present invention. The preexisting, contact information 902 stored in Microsoft Outlook may include the contact's name 904, address 906, company 908, phone number 910, email address 911, etc. After selection of the contact for import, the user may be provided with a selection of additional properties 912 that can be associated with the contact for purposes of an embodiment of the present invention. As shown in FIG. 9, such properties may include a first field 914 for identification of the relationship of the contact to the user (which may be associated with the roles previously established by the user) and a second field 916 for identification of the priority associated with the contact. Although not shown in FIG. 9, other properties may also include identification of a preferred delivery timing or delivery destination associated with the contact. The preexisting contact information 902 from Microsoft Outlook is then combined with the new additional system-related properties 912 into a single set of contextually enabled properties 918. These contextually enabled properties 918 are then stored in the active resources directory 110 in a contacts-related file 422. Based on these properties, each contact may then be associated with one or more predefined roles as identified in a role-related file 402 in the active resources directory 110.

4. Session-Based Navigation

In accordance with another aspect of the present invention, the navigation options provided by the user interface 102 may be session dependent. That is, information regarding where the user is and what the user has done in the system may be tracked and recorded in the active resource database 110. This information may then be utilized by the user interface 102 to actively and dynamically determine the user's best options for a next action, and to then display such best options to the user.

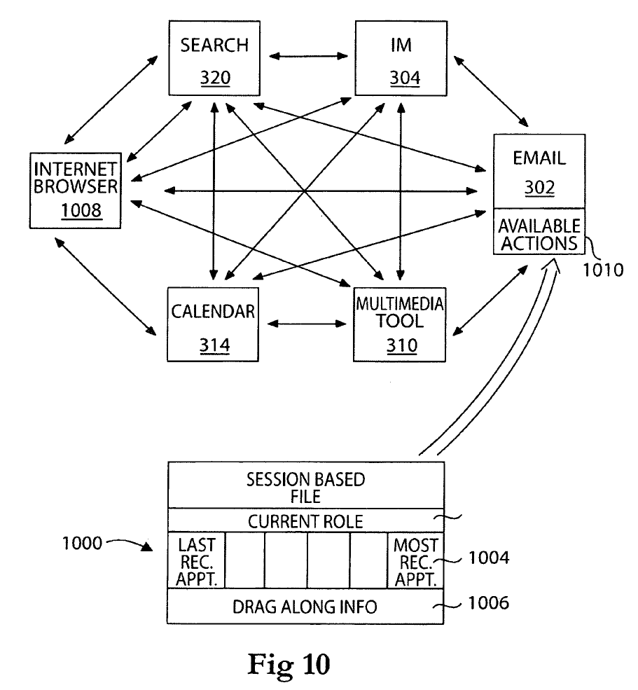

One exemplary embodiment of a session-based file 1000 for tracking a user's activities is illustrated in FIG. 10. As shown, the session-based file 1000 may include a first field 1002 to identify the current role-related window (e.g. “Work”) that the user is operating under. The session-based file may also include a second field 1004 identify the last x number of applications that the user has accessed (which may also include information regarding the functions utilized by the user while accessing each application), where x may be any integer number. In the embodiment illustrated in FIG. 10, the session-based file 1000 may also include a third field 1006 to identify any drag-along information that has been selected for the user to carry between applications or functions. The drag along information may include an object (such as a message, planner entry, search results, contact info, etc.) or any portion of any object (such as selected text, photos, videos, etc.)

As the user switches and transits between applications, the session-based file is continuously updated to track the user's session. In FIG. 10, exemplary applications are illustrated as including email 302, a multimedia tool 310, IM 304, search function 320, a calendar 314, and an internet browser 1008. However, it is understood that any other application may also be utilized and associated with the session-based file 1000. As the user accesses each new application, the user interface 102 accesses the session-based file 1000 and may then, based on the user's session history, alter or reprioritize the list of available actions 1010 provided to the user. The list of available actions may be provided to the user as menu options or in any other manner.

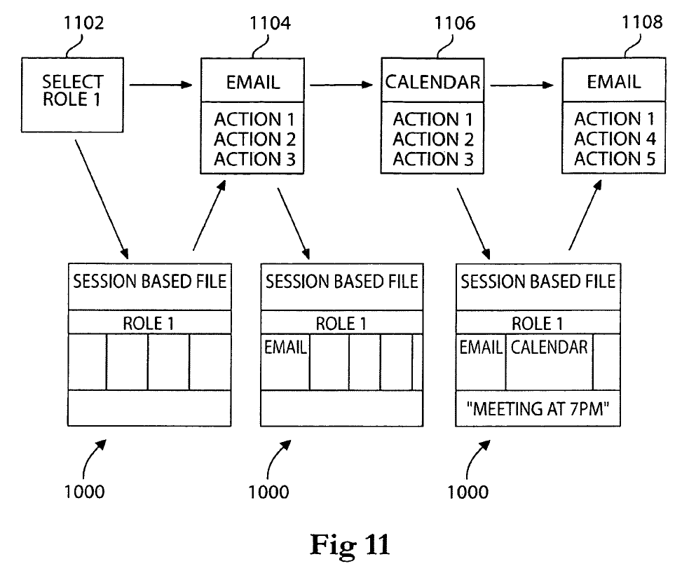

One illustrative example by which a session-based file 1000 may be used to alter available actions is illustrated in FIG. 11. In step 1102, a user selects a first role related window (e.g. Role 1). The user then accesses the email application in step 11104. Upon accessing the email application in step 1104, the available actions available to the user may be a first set of email-related actions (e.g. actions 1, 2, and 3). As shown in FIG. 11, with each action taken by the user, the session-based file 1000 is updated to reflect that the user has chosen Role 1 and accessed the email application.

After reviewing some email messages, the user then chooses to access the calendar application in step 1106. Again, the session-based file 1000 is updated to indicate that the user has accessed the calendar application following the email application. In the calendar application, the available actions for the user may be a first set of calendar-related actions (e.g. actions 1, 2, and 3).

Now, let us now assume that the user has noticed a calendar entry entitled “Meeting at 7 pm,” and desires to send a message to a coworker reminding the coworker of the meeting. The user can then select the “Meeting at 7 pm” entry in the calendar, which is stored in the drag-along information field of the session based file. In step 1108, the user again accesses the email application. The email application accesses the session based file, and identifies that the user has come from the calendar application and has selected to drag along a calendar entry. Accordingly, upon accessing the email application, user is now provided with a different set of available actions (e.g. actions 1, 4, and 5) based on the user's likely next action of creating a message containing the calendar entry. Of course, it is understood that all possible actions may remain available to the user, with only the presentation and prioritization of actions being altered based on information maintained in the session-based file.

In one embodiment, the available actions may also be influenced by information stored in the active resources directory 110. For example, let us now assume that a user has received an email regarding a doctor's appointment while accessing his health-related window, and has chosen to drag the appointment information from his email application to his calendar application to create an appointment entry. Upon setting the doctor's appointment, the available actions provided to the user may include actions to access the messaging suite in order to notify other relevant individuals who are part of his care team (i.e. friends, someone to drive him, therapist) of the appointment. Information regarding which individuals are to receive this information may be obtained by accessing the stored properties in the active resources directory 110.

5. Use Tracking

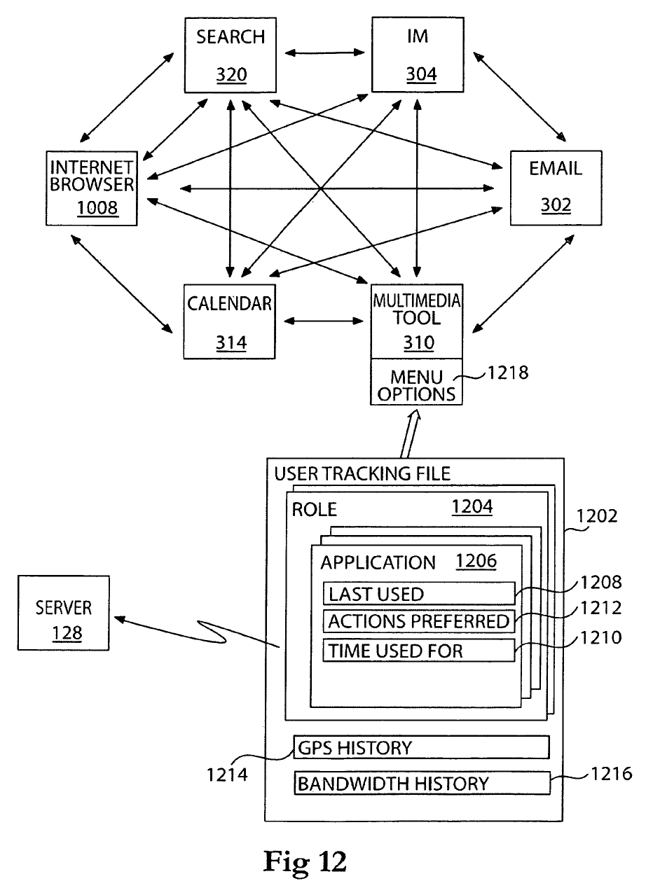

In another aspect of the present invention, the active resource directory 110 may also maintain information regarding long-term user information in a user tracking file. As shown in FIG. 12, the user tracking file 1202 may include a field 1204 for storing information regarding each role that user has established, a field 1206 for storing information regarding the applications the user has while operating under each role. For each application, the user tracking file 1202 may also include fields for identifying the last time the user has accessed the application (field 1208), the amount of time the user spent using the application (field 1210), as well as the types of actions performed by the user while using the application (field 1212). The user tracking file may also include a fields for tracking a user's GPS locations (field 1214) and available bandwidth (field 1216) on a time and day basis.

The information stored in the user tracking file 1202 may then be utilized to personalize and enhance a user's experience. In one embodiment, the information in the use tracking file 1202 may be utilized (alone or in combination with session-based file 1000) to alter or prioritize menu options 1218 available to the user when accessing any application or function in the system. In particular, menu option for any application or function may be altered based on the types of activities typically performed by the user. For example, if a user only utilizes the multimedia tool (which is described in more detail below) with photos as opposed to videos, the user interface for the multimedia tool may be altered to focus on photo-related menu options.

The use tracking file 1202 may also be utilized by the system to provide periodic reminders to the user in order to help balance the user's life. For example, based on the user's long-term use information stored in the user tracking file 1202, the system may be configured to inform the user when he has failed to review information relating to a specific role for a long time, or to inform the user that he has been spending an increasing amount of time on certain activities (e.g. work) to the detriment others (e.g. family and health).

Information regarding GPS location and bandwidth availability may be used by the system to anticipate times when the user typically either has increased or decreased network bandwidth capabilities. As a result, the system may be capable of improved scheduling of bandwidth intensive activities, such as transmission of large multimedia messages to and/or from the network.

In one embodiment, the voice recognition software 212 may also be used to diagnose, recognize, or interpret the “mood” of the user by tracking, for example, the frequency response, cadence, or tone of the user. This may occur during a phone call, while the user is recording audio information, or while the user is giving voice commands. Based on the identified “mood”, the system may then be configured to respond in various appropriate ways. For example, if the voice recognition software 212 determines that the user has had a stressful phone call with a parent, the user, upon completion of the call, may be provided with suggestions to relieve the stress, such as calling a friend, playing some favorite music, popping up a role window related to hobbies or other fun activities.

Information regarding a user's long-term activities may also be stored in an ARD network component on a remote server (e.g. server 128) along with use tracking files of other users. This information may then be searchable and accessible by third parties. As a result, users can easily search and locate others with similar interests or desires. Since the information stored in the use tracking file is based on actual usage, matches between individuals can be obtained more accurately than with typical social networking sites in which individuals simply state their alleged interests. The information in the user tracking file may also be utilized by advertisers to provided targeted advertising to users based on their actual interests.

6. Messenger Suite

A. General Functions

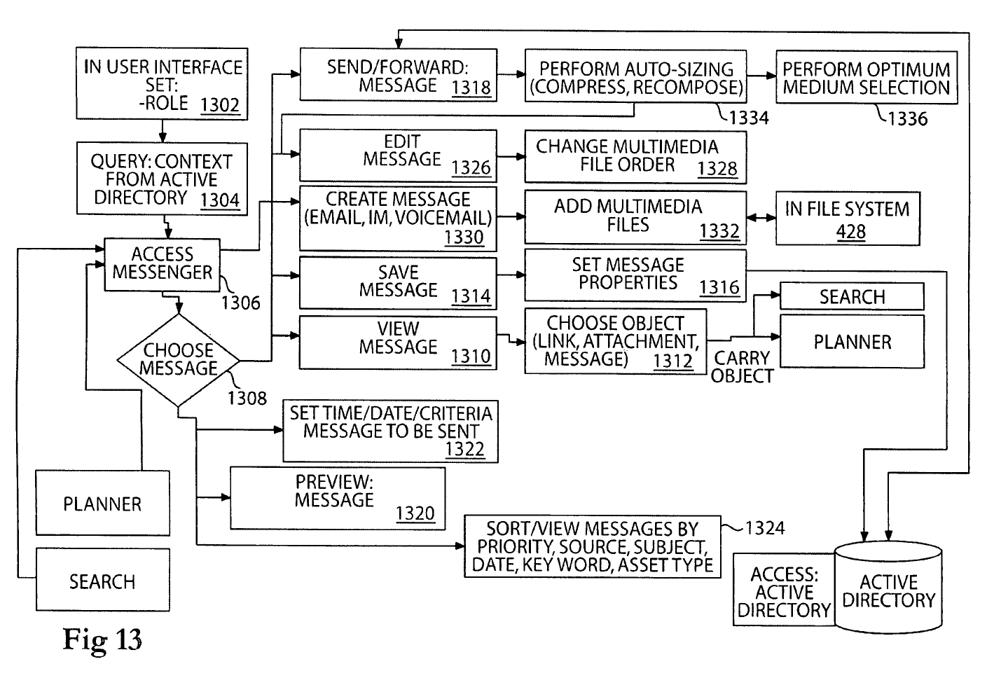

FIG. 13 is a flow diagram illustrating the functions that may be performed by the messenger suite 104 in accordance with one embodiment of the present invention. Starting from the user interface 102, a role window is chosen and set (step 1302), and a query is made to the active resources directory 110 in order to obtain information associated with the selected role (step 104). The user may choose then to access the messenger suite (step 1306), whereby the user can select a message (step 1308) and perform a number of actions relating to the message. Such actions may include viewing the message (step 1310), choosing a link, attachment or other object in the message (step 1312) in order to transmit or carry to the planner suite 106 or search suite 108; save the message (step 1314); set one or more properties of the message (step 1316); send or forward the message (step 1318); preview the message (step 1320); set the time/date/criteria for the message to be sent (step 1322), and sort or view messages by priority, source, subject, date, key word, digital asset type (step 1324). The user can also edit a message (step 1326) and, if the message is a multimedia message, alter or change information in the multimedia message (step 1328).

The user can also create messages (step 1330), such as email, IM, text/SMS, voicemail message and the like, add multimedia files (step 1332) from a file system 428 (which may be on the client device, a remote personal computer 126, or remote server 128), such as picture, movie, text, links and the like. When a message is sent, auto-sizing may also be invoked to match the message type being sent (step 1334), in terms of size and real-time priority, to the transmission medium such as wireless, wired type and the like, on the user transmit side and on the destination user's receive side. The auto-sizing function may also attempt to get the message through by invoking compression and medium selection (step 1336). If the message cannot get through entirely, only metadata, text information, and a notification may be sent to the sending and/or receiving users as to the message status and location, with the possibility that the message can be re-sent or retrieved by the receiving user later.

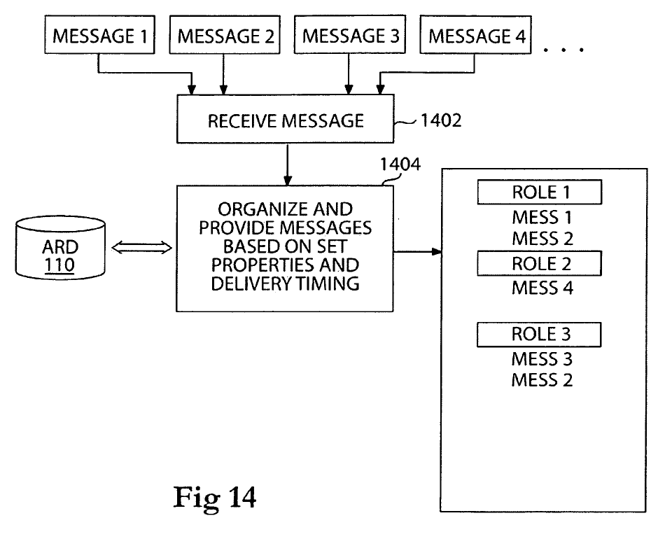

As illustrated by FIG. 14, incoming messages (e.g. Message 1, 2 3, 4, etc.) received by the client device (step 1402) may also be filtered into the appropriate role-related window based on content (such as by key words, links, object), contact properties, priority and delivery timing information stored in the active resources directory 110 (step 1404). As shown in FIG. 14, a single message (e.g. Message 2) may also be filtered into multiple role-related windows if the message is relevant to multiple roles in the user's life.

B. Multimedia Tool

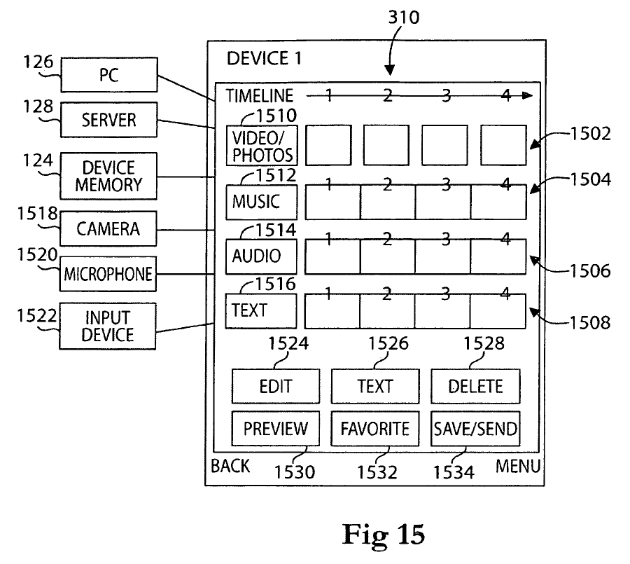

FIG. 15 illustrates one exemplary embodiment of a multimedia tool 310 in accordance with the present invention. In this embodiment, the multimedia tool 310 includes a plurality of timelines for different multimedia components that may be used to create a multimedia message, including a videos and photos (also referred to as visually-perceivable objects) timeline 1502, a music timeline 1504, an audio (i.e. user speech) timeline 1506, and a text timeline 1508 (collectively, “multimedia information”). Each timeline 1502-1508 is divided into a number of time slots to permit multiple pieces of multimedia information to be input sequentially into each timeline. In FIG. 15, lour time slots are displayed for each timeline. However, it is understood that any number or time slots may be provided to allow for numerous pieces of information of each type of be input into their respective timelines.

To populate a given timeline, a user clicks or selects the respective video/photo icon 1510, music icon 1512, audio icon, 1514, or text icon 1516. For example, to populate the video/photo timeline 1502, the user may click or select the video/photo icon 1510, upon which a list of available video and photos that can be utilized for the multimedia message are provided to the user for selection. The music, audio, and text timelines may be similarly populated. Alternatively, the user may also select a specific time slot (e.g. time slot 1, 2, 3, or 4) on the timeline for each of the video/photo, music, audio, and text in order to populate that specific time slot. Once a timeslot is populated, that time slot may also display an indicia indicating that the timeslot has been populated. Preferably, the indicia may also be indicative of the object that was used to populate the timeslot, such as a thumbnail, video extract, or the like. Each timeslot may also display or note the actual length of the media objects used to populate the timeslot to enable a user to easily synchronize the timelines for each of the different media objects and/or determine how to edit the various media object to enable proper synchronization.

As shown in FIG. 15, objects that may be used to populate a multimedia message may be obtained from multiple sources. For example, video, photos, music, audio, and text may be stored on a remote personal computer 126, a remote server 128 or in a device memory 124. Options to input the information directly from a camera 1518, microphone 1520, or other input device (such as a keypad) 1522 on the mobile device may also be provided. Thus, information used to populate a multimedia message may be preexisting information or information generated by the user while creating the message.

As shown, the interface for the multimedia tool may also include a number of selectable icons for providing additional options to the user. These may include and Edit icon 1524, a Text icon 1526, a Delete icon 1528, a Preview icon 1530, a Favorite icon 1532, and a Save/Send icon 1534. In one embodiment, selection of the Edit icon 1524 may provide an interface by which the user can trim the length of a particular video, music, and audio clip, crop photos, specify duration for which photos are illustrated, adjust volume, and edit text. Selection of the Text icon 1526 allows a user to manually enter text via a keypad or the like. Selection of the Delete icon 1528 allows a user to delete one or more items that have been inserted into one of the timelines. Selection of the Preview icon 1530 shows a preview of the compiled message in full screen. As would be understood by one skilled in the art, the compiled message includes the videos/photos, music, and audio selected by the user and arranged based on the locations of each media object in the respective timelines 1510-1514. In one embodiment, the text identified in time 1516 may be used to provide titles or other descriptions by overlaying the text onto the compiled message at the limes indicated by the location of the text in the timeline 1516. In another embodiment, the text may also be provided in a scrolling banner along an edge of the screen, and preferably below any videos/photos. In this embodiment, the user may also choose to have the text repeatedly scrolled one or more times during the multimedia message. Selection of the Favorite icon 1532 shows a user's previously identified favorite multimedia information. Selection of the Save/Send icon 1534 allows the compiled multimedia message to either be saved by the user, on the client device or a remote server, transmitted to a third party, or posted to a website (including public blogs, personal websites, company websites, or media sharing sites such as YouTube). The message may either be sent directly to another user as a multimedia message or may be embedded within another message type, such as an email, IM, SMS message, or the like.

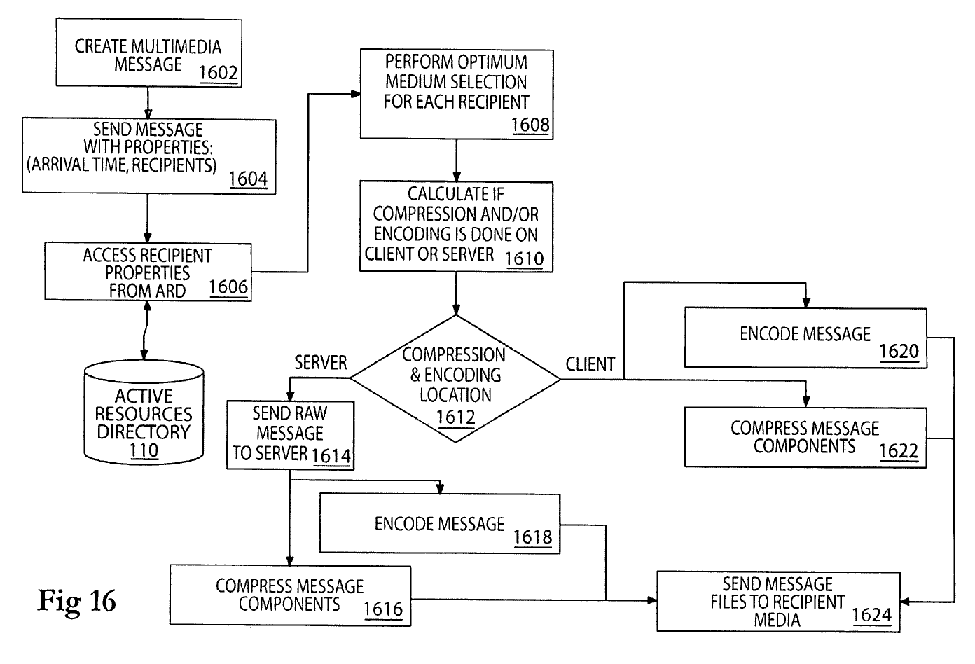

As shown in FIG. 16, the multimedia message may also be transmitted in multiple formats depending on the choice of the sender and/or the capabilities of the intended recipient. In step 1602, a multimedia message is created, for example using the multimedia tool 310 described in FIG. 15. In step 1604, the user selects to send the message. At this time, the user may also select any contextual properties, transmission criteria, and the intended recipients.

In step 1606, the multimedia tool 310 accesses active resources directory 110 to obtain any stored properties for the intended recipient, which may include, among others, the connectivity type of the recipient device, the types of applications present on the recipient device (i.e. whether the recipient device includes a multimedia tool), and any preferences for media type. Based on these properties, an optimum medium is selected for each recipient in step 1608. In step 1610, it is then calculated whether any necessary processing (i.e. compression and/or encoding) should be performed on the client device or at a remote device, such as a remote server or remote PC. In general, it may be advantageous to utilize a remote device if the processing power required for these actions exceeds the capability of the client device, if performing processing on the client device would interfere with other functions that needed to be performed on the client device, or if an identified transmission time could occur during a time when the client device would be unable to transmit the message. Such calculation is preferably performed automatically, although it is understood that the user may also be provided with an option to select or override the location where the processing is to occur. Methods for setting, analyzing, and transmitting messages based on different transmission criteria are discussed in more detail below.

In step 1612, the components chosen by the user to be included in the multimedia message are provided to the appropriate locations and software for processing. For example, if it is determined that processing should be performed at a remote device, the multimedia components are transmitted, preferably in RAW format, to the remote device in step 1614. Of course, it is understood that if components used for the multimedia message were originally located the remote device, such components need not be sent again to remote device and a pointer to the data may simply be provided instead.

The multimedia message is then processed into one or more available formats. For example, the multimedia message may be compressed for transmission in step 1616. The multimedia message may also be encoded, for example into MPEG4 format, in step 1618. In one embodiment, compressed messages may be altered or edited by a multimedia tool on a recipient device, while encoded messages cannot. In step 1624, the multimedia message is then transmitted to the recipient or recipients.

Whether an intended recipient is sent a compressed message or an encoded message may depend on a number of factors. In one embodiment, the creator of the multimedia message may select the format in which the message is transmitted. For example, the creator may send a compressed format if it is desired that the recipient be able to edit the message, while the creator may send a encoded message if editing is not desired. In another embodiment, whether a compressed or encoded message is sent may be determined automatically by the system. For example, the system may automatically send compressed files to recipients determined to have access to the multimedia tool, while sending encoded files to those recipients determined not to have access to the multimedia tool. It should also be understood that the multimedia message is to be sent to multiple recipients, different formats may be used for different recipients. Whether the message is compressed or encoded, the system may also be configured to provide a manual selection to the user for selecting the final size or resolution of the multimedia message to be transmitted, or to automatically scale the size or resolution of the message based on the medium on which it is being transmitted/received or the available bandwidth of the sender/recipient. The system may also be configured to inform the user if the selected final size or resolution cannot be transmitted using available resource transmission resources, and provide the user with an option to either resize the message or choose to transmit the message at a later time.

If it was determined that the processing should be performed at the client device, the selected multimedia components are then provided to the appropriate software on the client device in step 1612. The multimedia message is then compressed in step 1622 or encoded in step 1620 based on the factors and properties discussed above, and transmitted to the intended recipient media or medias in step 1624.

C. Message Transmission Manager

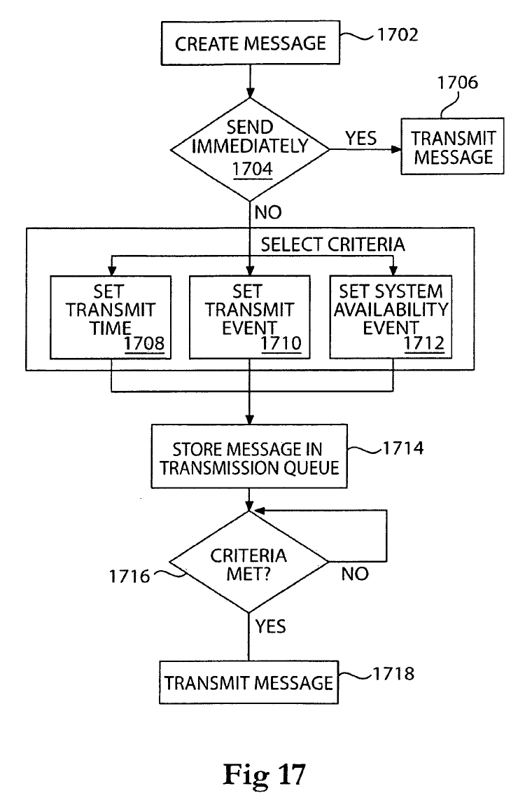

FIG. 17 is a flowchart illustrating one embodiment of the functions of a message transmission manager 312 in accordance with the present invention. In step 1702, the user creates a message. The message may be any type of message, including an email, text/SMS, IM, voice, or multimedia message. In step 1704, the user is provided with an option to either send the message immediately or set specific transmission criteria. If the message it to be transmitted immediately, the message is immediately transmitted to the intended recipient in step 1706. As noted above, the quality and size of the transmitted may be adjusted based on the quality of the available transmission medium and/or any preset information regarding the recipient.

If the message is not to be sent immediately, the user may be permitted to select various criteria for transmission of the message. For example, in step 1708, the user may select a specific date or time upon which the message is to be transmitted. In step 1710, the user may also set a specific event upon the occurrence of which the message is to be transmitted. Such events may include the recipient logging into their account, determining via GPS that the recipient is at a particular location, receipt of a message from another individual, or the like. In step 1712, the user may also set system availability criteria for transmission of the message. For example, in order to transmit a certain quality of message, the user may choose for transmission to occur only when the associated client device and/or recipient has access to a high-speed data connection, or when the user's and/or recipient's bandwidth is not being utilized for other tasks. Ascertaining the available bandwidth for the user and/or recipient may be conducted various methods. For example, in one embodiment, a test message may be sent from the client device to a remote server, which would then be transmitted back to the client device. Based on the round trip time and size of the test message, the system can ascertain the available upstream bandwidth. Downstream bandwidth may also be ascertained by transmitting a test file, such as a TCP test file or a Ping message, to an intended recipient.

In step 1714, the message is placed in a transmission queue until the criteria is met. In one embodiment, the message may be stored in a transmission queue on the client device. However, the message may also optionally stored in a transmission queue on a remote server along with the relevant transmission criteria. This permits a message to be transmitted when the criteria is met even if the user does not have access to a transmission medium at the time, for example, when a user is flying or the user is traveling in a location without a sufficient bandwidth connection. In step 1716, it is determined whether the transmission criteria has been met, After the transmission criteria is met, the message is transmitted to the intended recipient in step 1718.

In one embodiment, the message transmission manager 312 may also be configured to anticipate and react to events and circumstances that may effect transmission of the message. For example, let us assume that the user has set a message for transmission at 9 pm. However, the user's calendar also indicates that the user will be on a plane flight at that time. To ensure transmission of the message, the message transmission manager may select to offload the message to a transmission queue on a remote server to make sure the message can be transmitted at the proper time, or send the message prior to the time when the user is schedule to get on the plane. These actions may be taken automatically or provided to the user transmitting the message as options. The message transmission manager may also be configured, based on information in a user's use tracking file 426, anticipate the times in the user's day when increased bandwidth is typically available in order to enable transmission of larger multimedia messages.

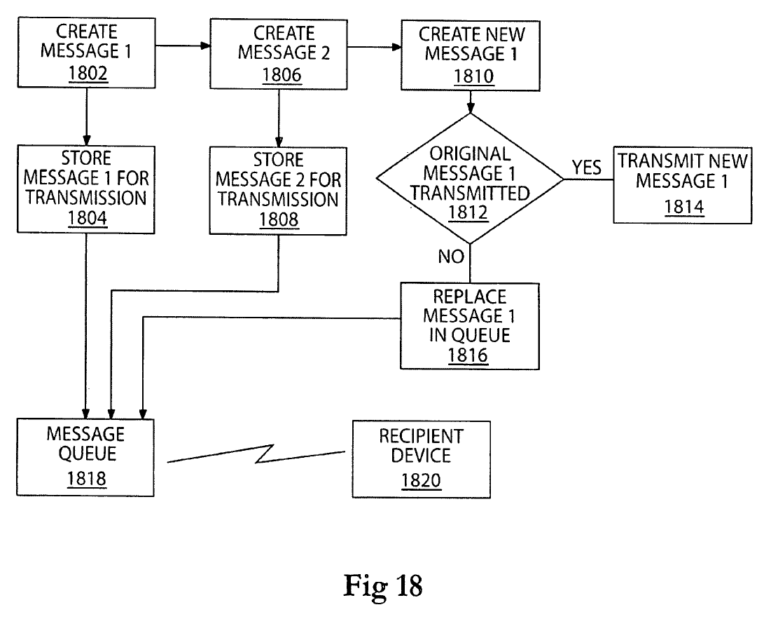

Messages that are placed in a transmission queue for future transmission may also be updated or replaced prior to their transmission. One exemplary embodiment for replacing a queued message is illustrated in FIG. 18. In step 1802, a first message is created by the user. In step 1804, the user then sets one or more transmission criteria for the first message, after which the first message is stored in the transmission queue 1818 for later transmission. In step 1806, the user creates a second message. In step 1808, the user may then set the transmission criteria for the second message, after which the second message is also stored in the queue.

Now, let us assume that, in step 1810, the user chooses to create a new message that is identified by the user as a new or updated version of the first message. In step 1812, the message transmission manager may determine whether the original first message had already been transmitted. If the original first message had been transmitted, the new first message is simply transmitted to the intended recipient 1820 as a separate message in step 1814. However, if the original first message had not been transmitted, the original first message may be replaced in the transmission queue, in step 1816, by the new first message using the same transmission criteria set previously for the first message. Of course, the user may also alter the transmission criteria at this time as well. As a result, the intended recipient will only receive the one new copy of the first message. This permits the creator of the message to fix any mistakes in the message prior to transmission, as well as preventing the recipient from having to unnecessarily receive and read outdated messages. Additionally, the message transmission manager 312 may also be configured to indicate that the prior message is available for replacement and/or provide the user with an option as to whether to keep or replace the prior message.

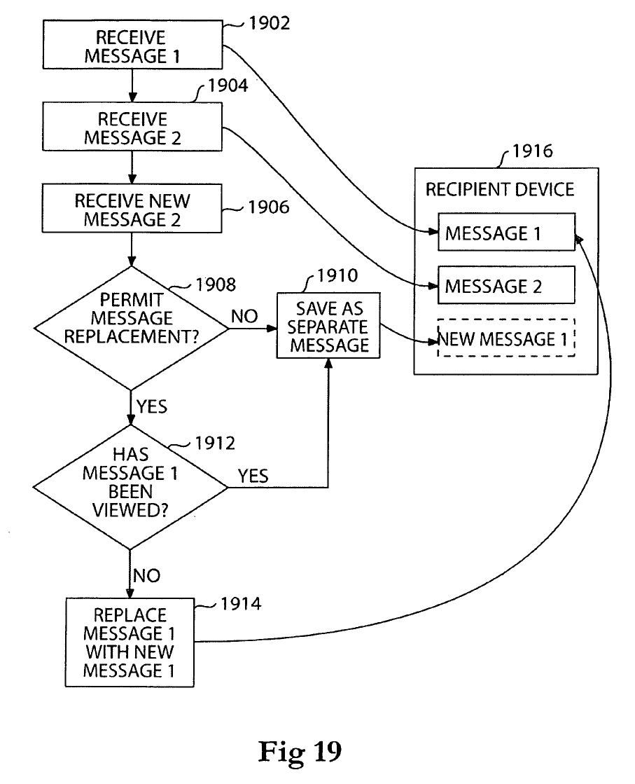

Similarly, the message transmission manager may also be configured to replace received messages if a new or updated message are received. One exemplary embodiment for replacing received messages is illustrated in FIG. 19. In this example, let us assume a first message has been received by a recipient device 1916 employing a system in accordance with the present invention in stop 1902, and a second message has been received by the recipient device in step 1904. As shown in FIG. 19, each of these messages are stored and made accessible to the user of the recipient device 1916. Assuming the user or the recipient device has set up multiple role-related windows, it is understood that the received messages may also be filtered and attributed to the proper role.

Now let us assume that a message, identified as being an updated or replacement message for first message, is received at the recipient's client device in step 1906. In step 1908, the message transmission manager 312 determines whether the user of the recipient device has permitted received messages to be updated or replaced with newer versions. If the user has not permitted this action, the replacement message is simply saved as an additional message in step 1910. If the user has permitted this action, it is determined whether the original first message has already been viewed by the user in step 1912. If it has, the replacement message is saved as an additional message in step 1910. However, if the user has not yet viewed the original first message, the original first message is replaced by the new replacement message, in step 1914, so that the user need only to read and review the updated message. As with the process described in FIG. 18, the message transmission manager may also be configured to notify the user of the replacement and/or provide the user an option of whether to keep or replace the original message.

7. Planner Suite

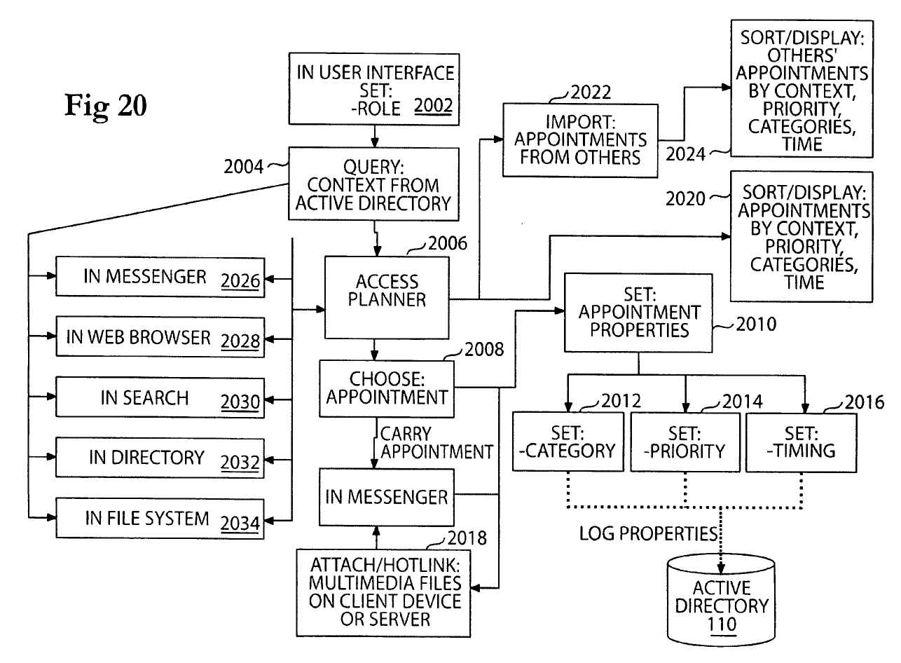

FIG. 20 is a flow diagram illustrating the functions that may be performed by the planner suite 106 in accordance with one exemplary embodiment of the present invention. Starting from the user interface 102, the user selects a role-based user interface (step 2002), and the context information is retrieved from the active resource directory 110 (step 2004). The user then accesses the planner suite (step 2006). Alternatively, the user could have been using other system functions including but not limited to applications in the messenger suite (step 2026), a web browser (step 2028), applications in the search suite (step 2030), a directory (step 2032), a file system (step 2034), and the like and then access the planner function.

Once in the planner suite, the user can view specific appointments, tasks and goals by days, weeks, months, etc. Particularly, as shown in FIG. 20, the user can choose to view or create a planner entry, for example an appointment, task, or goals (step 2008), and change any of its properties (step 2010), which may include setting, for example, the category (step 2012), priority (step 2014) and timing periodicity (step 2016) for the planner entry. These properties for the planner entry object are then written to the active resources directory 110. From the selected planner entry, the user may also add links to multimedia files, directory information, web pages, text, voicemail, documents and the like (step 2018). These files may be local to the client or simply a link or pointer to a file that physically resides on a remote PC or server. The user may also sort planner entries by context, priority, categories, time, date, and the like (step 2020).

In one embodiment, planner entries from other parties may also be imported (step 2022) according to opt-in or privacy rules set by the user and enforced by the active resources directory 110. These appointments imported from others can then be overlaid with the planner entries of the user. The imported appointments, tasks, and goals may also be sorted by context, priority, categories, time, date, and the like (step 2024).

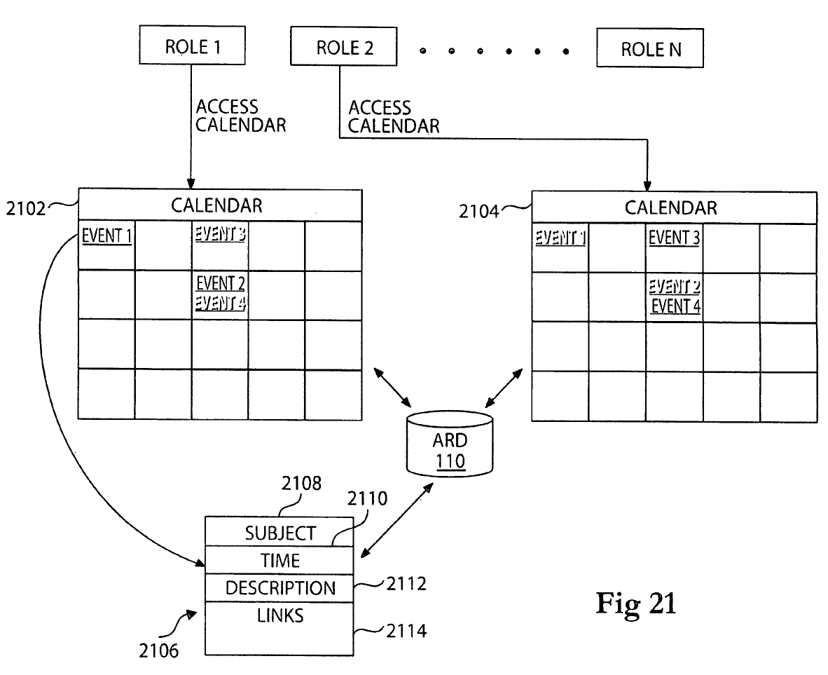

FIG. 21 illustrates one exemplary embodiment of the calendar application in accordance with the present invention. As shown, the calendar may be accessed via multiple role-related windows (e.g. Role 1 and Role 2 in FIG. 21), whereby the view of the calendar entries is altered depending on the role-related window used to access the calendar. In FIG. 21, appointments 1 and 2 are related to Role 1 while appointments 3 and 4 are related to Role 2. Thus, when a calendar window 2102 is accessed via Role 1, appointments 1 and 2 are illustrated prominently while appointments 3 and 4 are grayed out or show as being the background. Similarly, if a calendar window 2104 is accessed via Role 2, appointments 3 and 4 are illustrated prominently while appointments 1 and 2 are grayed out or shown as being in the background. Of course, other methods may also be used to distinguish between relevant and non-relevant appointments, such as increasing the size of role-relevant appointments, using different color, displaying only role-relevant appointments. Although not shown, similar techniques may also be utilized when accessing task lists, goals or any other type of planner entry.

Although not illustrated, the calendar application may also be configured to display the amount of time that role-related windows are accessed by the user in order to permit the user to see illustratively how much time is being spent on each role. To this end, the calendar application may generate time blocks associated with each of the role-related windows and display the time blocks in the calendar window. The time blocks can be viewed separately or in conjunction with other calendar entries. The calendar may then also be viewed and/or sorted by time blocks for specific roles.

As further shown in FIG. 21, each calendar entry 2106 may include information identifying the subject of the appointment 2108, the time of the appointment 2110, and a related description 2112. In accordance with the present invention, the calendar appointment entry 2106 may also include one or more hot links 2112 to one or more digital assets. The digital assets may be a URL, document, photo, video, pdf, web pages, audio file and e-mail. When viewing the entry, the user can then click on or otherwise select the hot link, thus accessing the digital asset. The digital asset may reside on the user's client device, on a remote personal computer, or on a remote server. The digital assets may also reside on third-party networds such as a company intranet, a phone carrier's network and the like. In one embodiment, the user may also create a message directly from an appointment on the planner that automatically includes information about that appointment. The information about that appointment can be information of hot links to digital assets. Although not shown, hot links to digital assets may similarly be associated with task lists, goals, or any other type of planner entry.

In one embodiment, digital assets associated with each calendar entry 2106 may be selected manually by a user. Alternatively, the planner suite may be configured to automatically associated digital assets with a calendar entry based on the contextual properties of the calendar entry and the available digital assets. For example, if a user creates a calendar entry regarding a doctor's appointment, the planner suite may access the active resources directory 110 to identify relevant digital assets to be associated with the doctor's appointment, such as previously received lab results, links to results of health-related searches recently conducted by the user.

Similarly, associated digital assets may also be accessed manually or automatically, For example, as noted above, a user can manually access any associated digital assets by clicking or otherwise selecting the respective link. Alternatively, relevant digital assets may be automatically provided to the user a predetermined amount of time before to the set appointment. Taking the example above, the lab Files and search results associated with the doctor's appointment may be provided to the user automatically a set amount of time before the appointment time. In one embodiment, the relevant digital assets may simply be accessed and displayed to the user. Alternatively, links to the digital assets may be provided prominently within the user's health-related role window so that the user can easily access the digital assets. In another embodiment, the user may receive a reminder or other perceivable notification asking whether the user would like to access the digital assets before his appointment.

In one embodiment, the navigation of the planner suite can be according to the buttons, stylus and touch screen. However, navigation may also occur via simple speech commands, as interpreted by the voice recognition software 212, referring to the application, time, date, appointment, start, finish and the like. Because of the relatively small phoenic dictionary required to permit accurate navigation of a calendar using speech commands, the calendar applications is especially amenable to navigation using speech commands, especially Where local memory resources are at a premium.

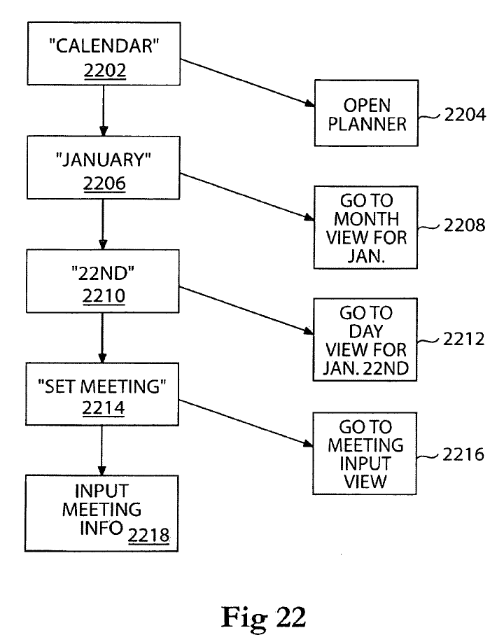

One exemplary embodiment for navigating a calendar application using speech commands is illustrated in FIG. 22. In step 2202, a user may state the word “calendar.” Upon recognizing the word “calendar”, the system may access the calendar application in the planner suite in step 2204. The user may also speak the “calendar” speech command while accessing any portion of the user interface or any other application, thus permitting quick and easy to the calendar whenever desired.

The user may then state a month to access calendar entries for that month. For example, as shown in FIG. 22, by speaking “January” (step 2206), the calendar applications accesses the calendar entries for the month of January (step 2208). The user may also state a specific date, for example “22^{nd}” (step 2210) to access the calendar entries for the 22^{nd} day of January (step 2212). Finally, the user may speak the words “set meeting” (step 2214), upon which the user may then create a new appointment for the 22^{nd} day of January (step 2216). To maintain the smaller vocabulary, input of the appointment information may be done utilizing non-speech input techniques such as keyboarding and pointer manipulations. Of course, it is understood that the spoken words shown in FIG. 22 are but examples and the system may be configured to recognize different words to access the various calendar application options.

8. Search Suite

A. General Functions

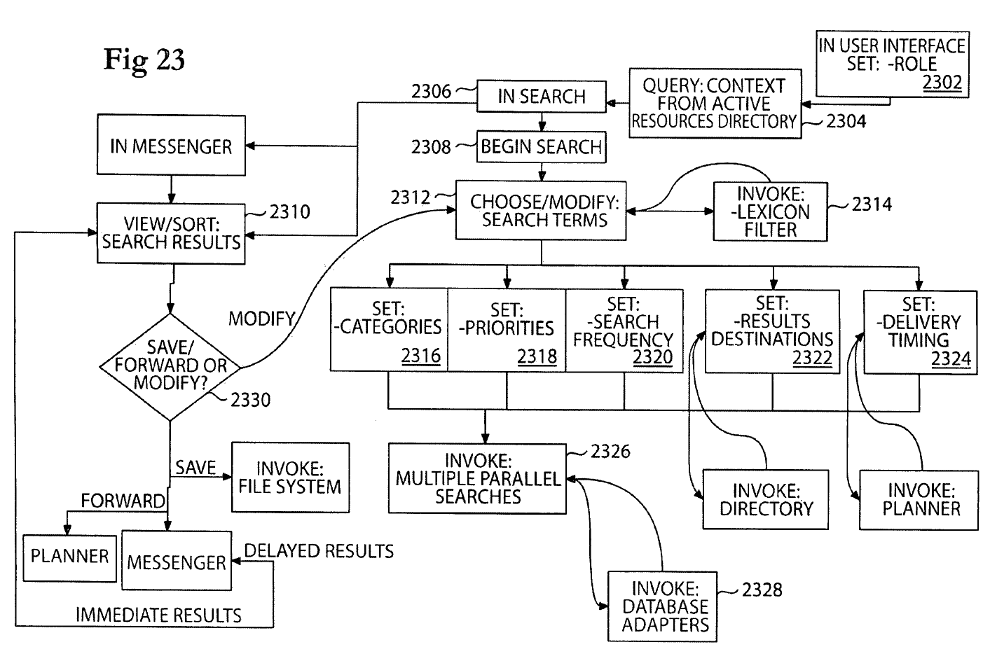

FIG. 23 is a flow diagram illustrating various functions of the search suite in accordance with one embodiment of the present invention. From the user interface 102, the user chooses a role-based window (step 2302), which associates the context of a query to the active resources directory 110 (step 2304). The user then begins a search (step 2306) by either beginning a new search (step 2308) or viewing/sorting an existing search results (step 2310).

If the user decides to begin a new search, the user can choose and/or modify search criteria (step 2312). This may include identifying the specific keywords or terms for the search, the databases to be searched, and/or the search engines to be used for the search. The search may also be configured to return only those results in one or more of the following categories: information, activities, people products and places. The keywords for the search may be input by the user. Alternatively, certain search terms may be pre-selected by the search suite based on previously configured user information. Such pre-selected search terms may then be altered or amended by the user. For example, in one embodiment, if the user wishes to search a database of other users with matching interests, the search terms may be automatically populated based on the user's own interests (for example, the roles established by the user). The user may then choose to search for matches based on all of the user's interests, or only a subset of the user's interests.

In one embodiment, the terms, keywords, or other elements from the context may also be displayed and/or considered as part of the search. This may include, for example, terms or keywords, or other contextual properties associated with a role being accessed by the user, relevant databases, information that has been selected by the user (i.e. drag along information), the types of information the user has recently accessed, etc. Such terms, keywords, or other elements may be displayed for the user so that the user may easily and quickly add them to the search being conducted. Alternatively, such terms, keywords, or other elements may also be automatically added to the search criteria in order to augment the search. For example, if the user is conducting a search while accessing his health role, one or more contextual properties of associated with the health role may be automatically added as search terms. The results of the search may also be limited or prioritized for results relating to health or that relate to one or more contextual properties associated with the health-role.

After search terms are selected, a lexicon filter may be applied to augment the search at the beginning (step 2314). The lexicon uses synonyms, antonyms, common word pairing associations, and foreign language terms to complement the search terms input by the user. In one embodiment, the lexicon filter may be configured to pare down multiple searches in order to perform deduplication. In another embodiment, the lexicon filter may also be configured to further enhance and clarify the search by conducting searches for synonyms of the selected keywords, antonyms related to the synonyms, and, in some instances, antonyms of the antonyms.

The user may also set the category (step 2316), priority (step 2318), search frequency (step 2320), results destination, including but not limited to, an email box, group ID, file system, and the like (step 2322), as well as the timing of the results delivery (step 2324). In setting the results destination, the active resources directory 110 can be invoked to permit the user to select a destination, for example a contact, to whom the results are to be sent. In setting the delivery timing, the user's planner suite can be invoked so that the user can see the results at a pre-scheduled time, rather than waiting for them in real-time. In this case, an event corresponding to the delivery time for the search results may be provided in the calendar application.

Once all the parameters of the search have been defined, multiple parallel searches, if desired, may be launched (step 2326). In one embodiment, the multiple parallel search may comprise a hierarchal search of the same database. The multiple parallel search may also involve searches of different databases using the same terms. Some of the searches can be web-based, Internet, and also intranet for business users, as well as other databases, including databases, of information regarding other users of the present invention. Some database may also require access to the library database adapter (step 2328), the function of which will be described in more detail below.

After the search results are returned, the search suite may be configured to combine and dc-duplicate the results, and sort the results in a structured manner according to the already defined user categories, priorities, key terms, and the like. The search results are then delivered, to the user or other recipients. The results may be provided to the user in any format. For example, the results may be provided via an email message. Alternatively, the results may be delivered to a folder in a file system. A notification of the results return may then be placed in the inbox (or appropriate role-related messages list) of the user as well as an indication in the planner suite that the results are ready.

When the user wishes to view results of a search, the user may see either a notification in a planner suite application or a messenger suite application, and will see the hyperlink to the content by opening that notification appointment or message. The results may also be edited, saved and forwarded (step 2330).

B. Hierarchal Searching

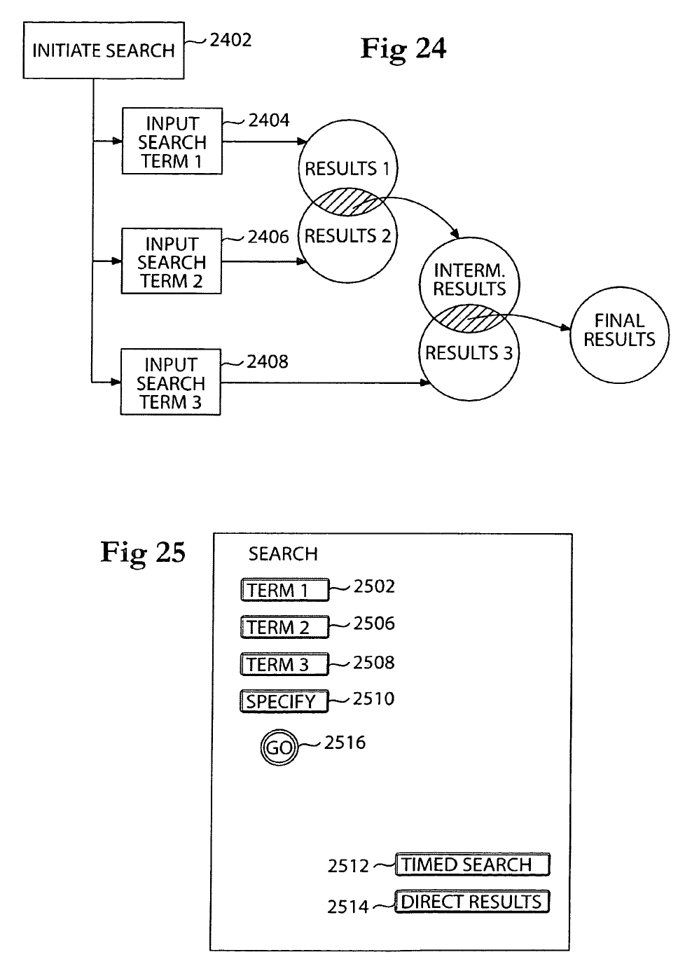

FIG. 24 illustrates one exemplary embodiment of a method for performing a hierarchal search in accordance with the present invention. In step 2402, the user accesses the search manager 320 to initiate a hierarchal search. In steps 2404, 2406, and 2408, the user inputs a series of search terms. In this embodiment, the hierarchal search is illustrated using three search terms, however any number of search terms may be used. Upon entering the three search terms, three separate searches of the same database are performed. The results of the three searches are indicated as Results 1, Results, 2, and Results 3, respectively. Results 1, 2, and 3 may also he temporarily stored, for example in cache 326 to enable comparison between the search results.

In one embodiment, Results 1 and 2 are first compared to identify the overlapping results (i.e. objects common among both searches). The overlapping results (also referred to herein as “intermediate results”) are then compared to Results 3 to identifying the next set of overlapping results. The overlapping results of the intermediate results and Results 3 are then identified as the final results and provided to the user. Applicants have determined that by virtue of this iterative process, search results can be obtained that are more highly relevant to the user as compared to a single search using all three search terms. Of course, it is understood that a different number of search terms may be used, and the order in which results are compared may be altered and the number of search terms is not limited to three, nor to odd numbers of search terms.

FIG. 25 illustrates one exemplary embodiment of a user interface that may be provided to permit a user to initiate a hierarchal search. As shown, three fields are provided for a user to input a first search term, 2502, a second search term 2506, and a third search term 2508. A SPECIFY icon 2510 is also provided to permit the user to select one or more properties for the search. This may include permitting the user to select the databases (i.e. public libraries, personal files, other user profiles, search engines, etc.) to be used for the search. This may also include permitting the user to specify a return location for search results. The return location can be a user inbox, a third person inbox, phone, address book, group address and a saved file. The user may also be permitted to specify results to be returned marked as a priority.

The user is also provided with a DIRECT RESULTS icon 2514 and a TIMED SEARCH icon 2512 to permit the user to select either to receive the results immediately or at a later time, respectively. If the user selects the TIMED SEARCH icon 2512, a separate menu may be provided to enable the user to select the criteria regarding when the search is to be provided. The search results notification can be provided as a notification, a phone call, e-mail, a message pop up, an instant message, a photo, video or audio file and the like. Additionally, upon selecting the TIMED SEARCH icon 2512, the user can identify the search as an automatic search and specify how often the search engine is to automatically perform the search. The search manager may also automatically determine which role-window is being utilized, and in response, add contextual parameters to the searches. Finally, to initiate the search, the user selects the GO icon 2516.

C. Multiple Database Search

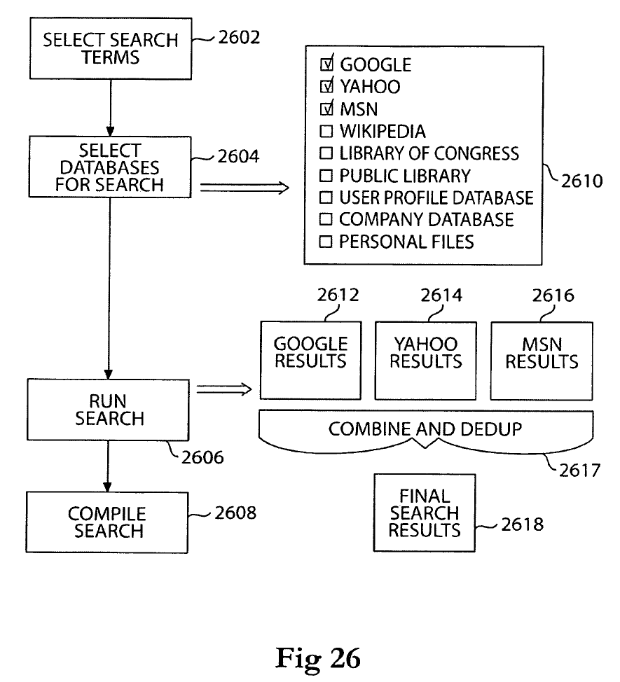

FIG. 26 illustrates one exemplary embodiment for performing a multiple database search. In step 2602, the user first selects one or more search terms for the search. In step 2604, the user selects one or more databases for the search. As shown, the selections may be made from a checklist of databases 2610 that may include public databases (such as the library of congress or wikipedia), private databases (such as the user's personal files or databases containing profile information of other users), and available search engines (such as Google, Yahoo, or MSN). Of course, these databases are provided merely as examples and are not intended to limit the present invention in any way.

A ter the user selects the databases, the search terms are used to perform a search using each selected database (step 2606). For example, in the embodiment shown in FIG. 26, a search was conducted using Google, Yahoo, and MSN, which returned three sets of results 2612, 2614, and 2616, respectively. The search results may be temporarily stored, for example in cache 326. The search results from each of the selected databases are then compiled in step 2608 to form a set of final results 2618. In one embodiment, compiling the search results includes combining the search results from each of the databases and removing any duplicate results. By searching multiple databases simultaneously, more relevant and refined search result are obtained in comparison to results performed by a single existing search engine. It should of course be understood that the multiple database search can be utilized separately or in conjunction with the hierarchal search.

D. Library Adapter

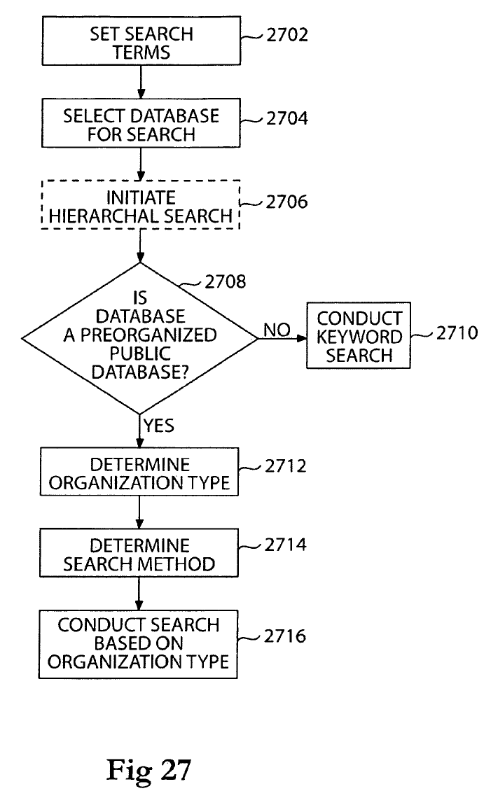

As noted above, a library adapter application may also be provided to automatically determine if a database accessed by the search engine is organized in a manner other than by key word. One exemplary embodiment of a process for performing a search utilizing the library adapter is illustrated in FIG. 27. In step 2702, the user first inputs a set of search terms. In step 2704, the user selects one or more databases for the search. In step 2706, the user may also optionally select whether to conduct the search as a hierarchal search.

Upon initiating the search, the library adapter automatically determines whether any one the databases being searched is a pre-organized database in step 2708. By way of illustration, one example of a pre-organized databases is a database organized with the Dewey decimal system. If the database is not pre-organized, then a typical keyword search is conducted in step 2710. However, if the database is pre-organized, the library adapter determines the organization type of the database in step 2712, determines a method for searching that organization type in step 2714, and conducts the appropriate search for that organization type in step 2716. For example, if the database is found to be organized using the Dewey decimal system, the search may be limited to those portions or the Dewey Decimal system in which the subject area corresponds to one or more of the search terms. As a result, searches of pre-organized databases can provide more relevant and refined results than a simple keyword search.

9. Additional Exemplary Use Cases

To further exemplify the features, functions, and advantages of the present inventions, a number of additional use cases are provided below describing methods in which the present invention may be used. It should be understood that these additional use case are merely for the sake of further illustrating the invention and are not meant to limit the present invention in any way.

A. Health Related Use Case for 60 Something Male Patient Post-Angioplasty

Aaron is a married patient who has suffered a mild stroke due to poor diet, lack of exercise and stress. He has just come through an angioplasty as a result of a partially blocked artery. His doctor is very concerned about post procedure follow-up given both Aaron's multiple issues and history of not following his doctor's recommendations. The doctor meets with Aaron and his wife Sara to discuss and show him several recommended after care activities. The doctor uses a smartphone to record video of several physical therapy movements; he uses Sara and Aaron together in the video to show the actual movements on Aaron's body. He then demonstrates Aaron's medicine regimen, taking photos of each specific pill type and color. Finally, knowing Aaron's habits, he narrates some very personal healthy eating advice, and tips on exercise. The doctor then uses all of these just created assets, along with preexisting medically approved diagrams, information and routines to create a series of multimedia messages. He discusses with Aaron and Sara their daily schedule, then sets the delivery of each message to arrive on a repeating basis to both Aaron's phone and Sara's phone, as well as their computer. The physical therapy message with “how to” video will arrive in the early morning as they wake up. The pill regimen message will arrive 3 times a day, while the exercise routine will arrive in the afternoon as motivation just before Aaron is supposed to use the treadmill. Sara, who still does most of the cooking for them, will receive the healthy eating tips and recipes while she is at the market.

All of this information will also be added to Aaron's Health-related role window, along with emergency contact information and specific pill prescriptions and contacts for the pharmacy. Reminders to get prescriptions filled will also be automatically filtered and set to arrive at specific times over each month. With Aaron's approval, other medical professionals who care for him will also receive the appropriate information about his situation, treatment and follow-up plan. In addition both Aaron's and Sara's calendars will be color-coded for the high priority items that must be handled each day, as well as follow-up appointments with various medical professionals. An emergency medical monitoring system is also set up where test results and symptoms of potential incidents will automatically trigger an email and call to the appropriate nurse or doctor; friends and family are also on this automatic contact list to make sure Aaron does not choose to just overlook the signs of trouble, like last time.

Whenever Aaron receives an email about an appointment with his doctor, he drags/drops the appointment data to his calendar. Upon doing so, the

All together these highly personalized resources, messages, and actions work as a system to ensure greater after-care compliance, follow-up and therefore better outcome for Aaron.

B. Health Related Use Case for 35 year old Female Technology Manager

Janet has a stressful job, and she tends to eat when she is stressed. So she started cycling. She created a “Tour de France” role to really get her motivation going. When Janet first started cycling she also realized she would benefit from some fellow enthusiasts to keep her on track. So she used the search suite 108 to perform a search of other users based on her love of cycling and exercise schedule (as set forth in the planner suite information contained in her active resource directory 110); which returned results of potential cycling buddies in the area near where she works (the address for which was loaded in the contact information of the ARID). Jane also uses set up automatic searches to continually get new ideas for safe cycling routes on her business trips (the locations for which can be drawn from the planner suite information in the active resources directory 110). Also, now when she is late at work and feels like just going out for a burrito instead of training, she receives a message on her phone from a cycling buddy, pre-set to 6:30 pm, with a multimedia message of him crossing the finish line in a bicycle race a month before. If Jane does not immediately respond to he system that she is leaving to bike, she receives a follow up message with motivational audio encouraging her to go bike riding. The motivation really works. While on the route, she also takes some on the fly video and photos as she reaches key points. She takes a break and sends the multimedia message to her support group of cycling enthusiasts, who always respond with either messages they made earlier and programmed to respond when they received hers, or they sent her encouragement in real time. The last time Jane left late but still managed to bike to the top of the hardest hill on her usual route, she even got a multimedia message just before reaching the summit (when she needed it most) from her best friend, Joan, who was traveling on the West Coast, telling Jane that she was doing a great job. Joan had set her phone (with Jane's manually granted permission) to automatically track Jane's phone GPS information and notify Joan in time to get a multimedia message out to Jane just before the summit! Of course, Jane could have programmed her phone to automatically send out a message to Jane just before the summit instead.

C. Business Related Use Case for 50 Something Male Road Warrior Executive

Joe is a divorced senior exec who sells mining equipment worldwide. Joe has created 3 role-related windows Work, Gourmet Food, and Family. Joe has also created sub windows under his Work role window for each of his client relationships. Each day he uses the search suite 108 to see the results of the automatic searches he has created, which constantly look for new information about each client's markets, executives, and product developments. When a particularly important contract is coming up, Joe puts a high priority on the searches for that client so he will be notified immediately without even having to go to the results page.

Simultaneously Joe has also set up the search suite to search the database of other users to continuously search job sites for a mining engineer who can work for him part time on sales proposals. During the week Joe has configured his various Work role windows to search for important information from the Internet relating to his company and attach it as live links to the dates of key meetings on his calendar application; in this way search results are waiting for him to refer to whenever he is available, such during a conference call somewhere in the world.

On a business trip, when Joe personally observes that a target customer's job site is using the wrong equipment from a competitor, Joe uses the multimedia tool to shoot a quick video, record an audio message, write some specific points over the exact place in the video where he would do it differently, and then drags and drops from his company's intranet a PDF tear sheet describing his company's correct piece of equipment. All this is previewed, edited and combined into a rich message, for which he then sets the timing on the created on the fly “sales pitch” to arrive on the target customer's email at 9 am local time the next day when Joe knows the client will be getting back from a trip. Meanwhile Joe gets on a plane for his next destination.

Finally Joe stays close to his kids and grandkids by importing their calendars into his planner suite where he sees all the events according to different colors. He knows they are all going to be together at a Sunday dinner (while he will be on an overnight flight). So, before Joe gets on his flight, he sets a message to arrive just before his kids and grandkids sit down with a quick multimedia message showing him eating his breakfast in Shanghai with a photo of the menu in Chinese and an audio greeting from the host who is an old friend.

Also attached is an invitation from his planner suite asking them to meet him for dinner the following week when he comes through San Francisco. Joe has used his Gourmet Food Role Window to do multiple searches and Find not just a great restaurant that has his favorite lobster dish but one that also features vegetarian food for his granddaughter; he attached the information and address to the planner invitation so the kids and grandkids had all the information. They, in turn, make a multimedia message at the Sunday dinner, set it to greet Joe when he lands, and attach an invitation to include him in their monthly instant message “meeting” just for grandkids and grandpa, an invitation that is automatically is filtered to go into his family window and is automatically marked a super priority in his Calendar.

D. Consumer-Related use Case for 40 Something Woman with Child and Elderly Father

Karen is a married, working mom who would like to lose a few pounds, has an elderly father with cancer, wants some artistic outlet in her life, and dreams of restarting the romance with her husband, all while raising a 9 year old daughter soccer star. Karen has created five role-related windows for Health, Daughter, Work, Love, and Painting.

In her Health window, Karen uses the search suite to constantly look for new ways to lessen her father's pain. She also sets a search to find a support group for people who take care of people with cancer. Karen also set up in her messenger suite an emergency notification system; in case her father has serious problem while she is on a business trip, so she can, with one button on her mobile device, automatically call and email the people who can get to her father immediately including the main nurse practitioner at the oncology center where her father's doctor practices. And lastly, Karen set up sub window under the Health-related role window just for her weight; she gets a daily feed of links to motivational videos, while the search suite is also configured to automatically look for new low cal recipes with great taste Karen can have with her family.

In her Love window, Karen uses her planner suite to invite her husband for stolen dates once a month—attached to the invite is a photo montage from the hotel and directions. Then a day before the date, Karen uses the messenger suite's multimedia tool to include a little video of her, and a quick hit of their favorite song; she pre-sets the message to arrive the next morning two hours before their “lunch date.”

In her Daughter window, Karen has used the messenger suite to set up a group for her fellow soccer moms. Anytime Karen is stuck with clients when it is her turn to pick up the girls, she hits a button and sends out an emergency notice, and within an hour someone has volunteered to cover the carpool for her. Also when Karen is traveling and her daughter has a game, in the morning Karen uses the messenger to create a “go for it” multimedia message and presets it to arrive 10 minutes before the game on her daughter's phone. Karen has also pre-set regular messages to remind her daughter to send fun multimedia messages to her sick grandfather; Karen's daughter loves to send them just before he goes in for chemo. Her grandfather lives for them.

In her Work window, Karen creates many sub window for each consulting project she handles. From within each sub window she keeps up to speed on the project by using her messenger suite and its multi-media attachments to create pre-set weekly update “virtual” meetings with core project members. Karen also exports her work-related calendar entries to her customers, with other personal priority times just blocked out, so they know when the best time to schedule something with her. She also views her Planner regularly, by Role windows, to see how much of her time is being spent on her priorities; it is here that Karen see how little time she has carved out for her painting.

Finally, in her Painting window, Karen has only had time to use the search suite to look for other painters who love Plein Air; she has created a series of relationships with painters from all over the country who keep each other inspired by sharing from their planner suites the times and places they are painting out of doors. She also gets a message from the one woman in Australia who sends her, via the multimedia tool, short scenes and music and photos of her latest painting, all done in an edited, motivational manner. Karen resolves to put two hours for painting in the Planner for Saturday morning as her “line in the sand”.

E. Consumer-Related Use Case for 16 Year Old Student with Academic Pressure and Active Social Life

Emma is an honors student who is also wildly popular, but has tremendous pressure from parents to gel into a good college. Emma has created four role-related windows for School Work, Friends, College, and Secret Garden/Home Base.

Emma uses her School Work window to create a sub window for each subject she is taking. She then uses the fact that the search suite in each one can be set to do multiple searches and simultaneously to have them help her research everything she needs from the Internet and various public databases, while she is in class! She sets each subject window to “meet” with her at a certain time of the day to review the results from the searches. She then refines the various searches to find more specific results and sets another meeting for homework time later that afternoon.

Emma uses her Friends window constantly. She uses the messenger suite to send and receive multimedia messages of every shape all day long. If she knows a friend is going to see at lunch a boyfriend she had a fight with the night before, Emma creates a special supportive message with music and photos that she pre-sets to arrive just before lunch. She really loves to just send to her many friends quickly edited 15 second videos that show various funny things that happened to her during the day. Emma has also used the search to set up several searches to find friends across the world; for each one she chose only what she wants to share about herself (from her photos, music, videos, links, words) for that group. She then shares only that part of her planner suite that has to do with each search so she keeps her privacy and control. Emma also uses her planner suite to do invitations for the many social activities she schedules and attends. So instead of having to call or email each of her friends when something is coming up, she just, clicks on a button, adds cool photos and some music and the invite goes out with all the information and fun!

Emma uses her College window to create sub windows for each of the universities and towns she is interested in. She uses the search suite to create multiple and simultaneous searching to find out interesting aspects of what life would be like going to each college. She sets a “meeting” with these sub windows for Saturday morning when she has time to view the results. She also refines the sub windows into favorites, so some colleges are given more priority in the results page. She has used the search suite to search for other kids are thinking of going to each school. But Emma especially values the ability of her search suite's hierarchal searches to zero in on the key aspects of each college's admission's approach, so she can know how and whether to apply to each one!

Finally, though Emma is a popular girl, like all teens she needs encouragement and self-esteem building. She uses the Secret Garden/Home Base window to store videos, messages, music, and links that are sources of support. Whenever she is feeling too much pressure, she uses her messenger to call up a multimedia message she created that has a photo of her beloved grandmother and a MP3 of her playing Chopin on the piano; it reminds Emma of what really matters in life.

F. Military-Related Use Case

Assume that there are mobile patrols requiring coordination via a central, theater-based command, and that the theater command also must report and receive instructions from a nationally centric command.

The mobile patrols are assumed to have WiFi/WiMax or other 3G/4G wireless connectivity to client devices employing the present invention. The patrols are assumed to be exploring city sectors, participating in conversations with locals and local militia, finding changes in the environment in terms of adversary boundaries, capabilities, key personnel shifts, etc. Military personnel can use client devices having the present system to take snapshots, short movies, audio clips, make annotations, and append text to create multi-media shows which can then be sent to a theater-based fusion center. The center expertise, which includes language translation, GPS mapping capabilities, collection of related intelligence in-theater and from national centers, can then fuse multiple multimedia messages together to provide direct intelligence value to the mobile units and the national intelligence centers.

The fusion center personnel will have the ability to receive multiple multimedia messages, view them, parse them, send either parts or other multimedia products to other personnel, and to then subsequently recombine and add digital assets into new multimedia messages. An example would be intelligence collected in the form of pictures and some audio clips. Arabic translators were not available (either written or spoken) in the field, but such translators (as shared resources) are available at the fusion center. The translators can then interpret what is coming from various multimedia components (audio and picture) and the military personnel can then send instructions, verbal audio track and a map overlay, down to the relevant mobile units to either explore the situation further or to engage with certain local units. The multimedia message information can also be used to augment theater (or city) information as to the movements, posts and capabilities of the adversary by overlaying the GPS and pictorial information from a number of multimedia messages onto a common GPS system. The combined GIS information can then be used to send instructions to the mobile units as to what boundaries and locations to engage or avoid. The fusion of multiple multimedia messages enables a timely and accurate control command and loop. Finally, military intelligence products (reports) are required to be sent to national or regional commands. Again, the multimedia tool can recombine multiple multi-media shows into well-edited multimedia messages, with annotations and timely viewpoints (text and voiceover), to be sent to the relevant national intelligence centers.

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A messaging system for a mobile device comprising:
a multimedia tool; and
a user interface associated with the multimedia tool, the user interface being configured to permit a user to select a plurality of media objects and identify an order in which the plurality of objects are to be arranged;
wherein the multimedia tool is configured to assemble the plurality of media objects into a multimedia message, select a format in which the multimedia message is to be transmitted, and transmit the message to at least one intended destination in the selected format.

2. The messaging system of claim 1 wherein the plurality of media objects include at least two of visually-perceivable objects, music objects, audio objects, and text objects.

3. The messaging system of claim 2 wherein the user interface is configured to display a length associated with each of the selected plurality of media objects.

4. The messaging system of claim 2 wherein the user interface is configured to permit a user to input text objects using a keypad interface.

5. The messaging system of claim 2 wherein text objects are displayed in a banner below visually perceivable objects

6. The messaging system of claim 1 wherein the plurality of media objects include each of visually-perceivable objects, music objects, audio objects, and text objects.

7. The messaging system of claim 1 wherein the user interlace associated with the multimedia tool includes:
a first timeline having means for permitting user selection of one or more visually-perceivably objects, and means for permitting user selection of locations in the first timeline for each of the one or more visually-perceivable objects;
a second timeline having means for permitting user selection of one or more music objects, and means for permitting user selection of locations in the first timeline for each of the one or more music objects;
a third timeline having means for permitting user selection of one or more audio objects, and means for permitting user selection of locations in the first timeline for each of the one or more audio objects; and
a fourth timeline having means for permitting user selection of one or more text objects, and means for permitting user selection of locations in the first timeline for each of the one or more text objects.

8. The messaging system of claim 7 wherein the visually-perceivable objects are at least one of a video object and a photo object.

9. The messaging system of claim 1 wherein the multimedia tool is further configured to access one or more properties stored in an active resources directory; and select the format in which the multimedia message is to be transmitted based on the one or more properties.

10. The messaging, system of claim 9 wherein the format is selected from one of a compressed format and an encoded format.

11. The messaging system of claim 1 wherein the multimedia tool is further configured to select a first device from a plurality of devices to perform assembly of the plurality of media objects into the multimedia message.

12. The messaging system of claim 11 wherein the plurality of devices includes a mobile device hosting the multimedia tool and a remote device.

13. The messaging system of claim 1 wherein the multimedia tool is further configured to select a first device from a plurality of devices the device to perform transmission of the multimedia message to the at least one intended destination.

14. The messaging system of claim 13 wherein the plurality of devices includes a mobile device hosting the multimedia tool and a remote device.

15. A method for transmitting multimedia messages in a mobile device comprising:
receiving, via a multimedia tool, a plurality of user-identified media objects to be utilized for forming a multimedia message;
accessing one or more properties in an active resources directory;
selecting, based on the one or more properties, a format from a plurality of available formats in which the multimedia message is to be transmitted; and
transmitting the multimedia message to one or more intended recipients in the determined format.

16. The method of claim 15 wherein selecting the format included determining whether to compress or encode the plurality of user-identified media objects to form the multimedia message.

17. The method of claim 16 further including selecting from a plurality of devices that is to perform the compression or encoding of the multimedia message.

18. The method of claim 17 wherein selecting from the plurality of devices includes automatically selecting between a mobile device hosting the at least one messaging application and a remote device.

19. A system for transmitting multimedia messages in a mobile device comprising:
means for receiving a plurality of user-identified media objects to be utilized for forming a multimedia message;
means for accessing one or more properties in an active resources directory;
means for selecting, based on the one or more properties, a format from a plurality of available formats in which the multimedia message is to be transmitted; and
means for transmitting the multimedia message to one or more intended recipients in the determined format.

20. The method of claim 19 wherein the selecting means includes means for determining whether to compress or encode the plurality of user-identified media objects to form the multimedia message.

21. The method of claim 20 further including means for selecting from a plurality of devices that is to perform the compression or encoding of the multimedia message.

22. The method of claim 21 wherein the means for selecting from the plurality of devices includes means for selecting between a mobile device hosting the at least one messaging application and a remote device.
